(19) United States
(12) Patent Application Publication
(10) Pub. No.: US 2017/0060413 A1
(43) Pub. Date: Mar. 2, 2017

(54) METHODS, APPARATUS, SYSTEMS, DEVICES AND COMPUTER PROGRAM PRODUCTS FOR FACILITATING ENTRY OF USER INPUT INTO COMPUTING DEVICES

(71) Applicant: DRNC Holdings, Inc., Wilmington, DE (US)

(72) Inventor: Mona Singh, Cary, NC (US)

(73) Assignee: DRNC Holdings, Inc., Wilmington, DE (US)

(21) Appl. No.: 15/119,574

(22) PCT Filed: Feb. 21, 2015
(86) PCT No.: PCT/US15/16983

§ 371 Date: Aug. 17, 2016

Related U.S. Application Data
(60) Provisional application No. 61/942,918, filed on Feb. 21, 2014.

(51) Int. Cl. G06F 3/0488; G06F 3/01; G06F 3/023; G06F 3/0482

(52) U.S. Cl. CPC G06F 3/04886; G06F 3/0482; G06F 3/0488; G06F 3/013; G06F 3/0233; G06F 3/0237

(57) ABSTRACT

Methods, apparatus, systems, devices, and computer program products for facilitating entry of user input into computing devices are provided herein. Among these may be a method for facilitating data entry, via a user interface, using a virtual keyboard adapted to present an alphabet partitioned into sub-alphabets and/or in a QWERTY keyboard layout. In examples, display characteristics of one or more virtual keys may be altered and/or a subset of virtual keys with corresponding characters may be provided in the virtual keyboard layout based on a likelihood they may be used next by a user and/or a probability of them being used next by a user.

### CROSS-REFERENCE TO RELATED APPLICATIONS

This application claims the benefit of U.S. Provisional Application No. 61/942,918 filed Feb. 21, 2014, which is hereby incorporated by reference herein.

### BACKGROUND

Devices such as mobile phones, tablets, computers, wearable devices, and/or the like include an input component that may provide functionality or an ability to input data in a manner that may be suited to the type of device. For example, devices such as computers, mobile phones, and/or tablets typically include a keyboard where a user may tap, touch, or depress a key to input the data. Unfortunately, such keyboards may not be suitable for use in a wearable device such as a smart watch or smart glasses that may not have similar or the same ergonomics. For example, such keyboards may be QWERTY keyboards that may not be optimized for working with eye gaze technology in wearable devices such as smart glasses, and generally, a lot of effort and time may be expended to input data. As an example, commands like Shift-Letter for uppercase letters are not intuitive to users, and inconvenient or impossible to select when a user is not using two hands. Moreover, data input should be intuitive (e.g., not an extension of such keyboards) simply because the mobile device market including wearable devices includes users who have never used computers.

### SUMMARY

Methods, apparatus, systems, devices, and computer program products for facilitating entry of user input into computing devices are provided herein. Among these may be a method for facilitating data entry, via a user interface, using a virtual keyboard adapted to present an alphabet partitioned into sub-alphabets and/or in a QWERTY keyboard layout. In examples, display characteristics of one or more virtual keys may be altered and/or a subset of virtual keys with corresponding characters may be provided in the virtual keyboard layout based on a likelihood they may be used next by a user and/or a probability of them being used next by a user.

The Summary is provided to introduce a selection of concepts in a simplified form that may be further described below in the Detailed Description. This Summary is not intended to identify key features or essential features of the claimed subject matter, not is it intended to be used to limit the scope of the claimed subject matter. Furthermore, the claimed subject matter is not limited to the examples herein that may solve one or more disadvantages noted in any part of this disclosure.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals in the Figures indicate like elements, and wherein:

FIG. 1 is a histogram illustrating relative frequencies of the letters of the English language alphabet in all of the words in an English language dictionary;

FIG. 2A is a block diagram illustrating an example of a system in which one or more disclosed embodiments may be implemented;

FIGS. 2B-2H are example displays of a user interface of an application executing on a device;

FIGS. 3A-3D depict example interfaces or displays of a user interface of an application executing on a device;

FIGS. 4A-4D depict example interfaces or displays of a user interface of an application executing on a device;

FIG. 5A is a system diagram of an example communications system in which one or more disclosed embodiments may be implemented;

FIG. 5B is a system diagram of an example wireless transmit/receive unit (WTRU) that may be used within the communications system illustrated in FIG. 5A; and

FIGS. 5C, 5D, and 5E are system diagrams of example radio access networks and example core networks that may be used within the communications system illustrated in FIG. 5A.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein.

Methods, apparatus, systems, devices, and computer program products for facilitating entry of user input into computing devices, such as wearable computers, smartphones and other WTRUs or UEs, may be provided herein. Briefly stated, technologies are generally described for such methods, apparatus, systems, devices, and computer program products including those directed to facilitating presentation of, and/or presenting (e.g., displaying on a display of a computing device), content available such as a virtual keyboard that includes virtual keyboard layout. The virtual keyboard layout may include at least a set of virtual keys with, for example, one or more corresponding characters for selection as user input. For example, the content (e.g., which may be selectable content) may include alpha-numeric characters, symbols and other characters (e.g., collectively characters), variants of the characters (“character variants”), suggestions, and/or the like that may be provided in virtual keys in a virtual keyboard layout of the virtual keyboard. The methods, apparatus, systems, devices, and computer program products may allow for data input in a device such as a computing device equipped with a camera or other image capture device, gaze input capture device, and/or the like, for example.

In one example, the methods directed to facilitating presentation of, and/or presenting on a device such as a wearable, content (e.g., one or more virtual keys and/or one or more characters that may correspond to or be associated with the one or more virtual keys) available for selection as user input may include some or all of the following features: partitioning an alphabet into a plurality of partitions or subsets of the alphabet (collectively “sub-alphabets”); determining whether or which characters of the alphabet to emphasize; and displaying, on the device in separate regions (“sub-alphabet regions”), the plurality of sub-alphabets, including respective emphasized characters, for example.

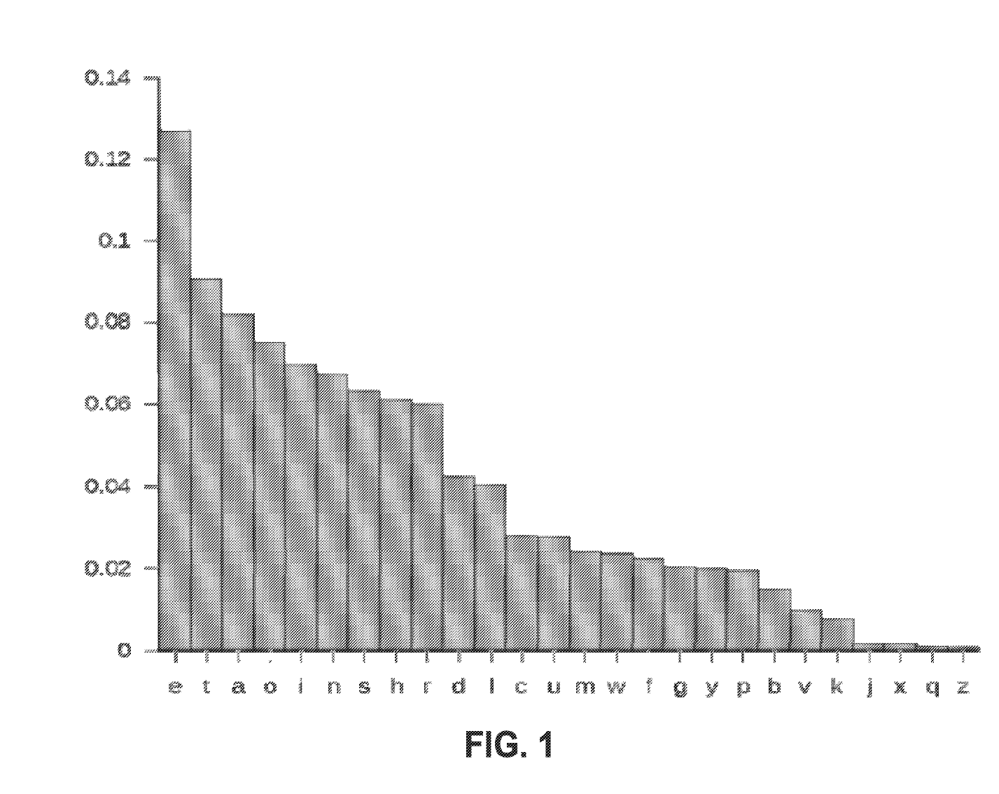

Examples disclosed herein may take into account the following observations regarding languages, text, words, characters, and/or the like: (i) some letters of a language's alphabet may appear more frequently in text than others, and (ii) a language may have a pattern in which the letters appear. An example of the former is shown in FIG. 1, which illustrates a histogram showing the relative frequencies of the letters of the English language alphabet in all of the words in an English language dictionary. As shown, the vowel e may appear more frequently that the other characters, the consonant t may appear more frequently that the other characters except the vowel e, and/or the like. As used herein, a frequently-used character (e.g., consonant, vowel, numeral, symbol, and/or the like) may refer to a character whose attendant relative frequency or occurrence in a text or other collection of terms may be above a threshold frequency or threshold amount of occurrences in such text or other collection of terms. An example may include or may be that the letters that form syllables (e.g., a syllable structure) in the English language may follow any of a consonant-vowel-consonant (CVC) pattern, consonant-consonant-vowel (CCV) pattern, a vowel-consonant-consonant (VCC) pattern, and/or the like. Diphthongs, e.g. “y” in English, often work like vowels.

As described herein, in examples, a virtual keyboard having a virtual keyboard layout in accordance with one or more of the following features may be generated and/or provided. For example, consonants and vowels sub-alphabets may be presented in separate, but adjacent sub-alphabet regions, allowing a user to hop between consonants and vowels in a single hop when inputting data; the consonants sub-alphabet may be presented in two separate sub-alphabet regions, both adjacent to the vowels sub-alphabet region, the consonants classified as frequently-used consonants may be presented one consonants sub-alphabet region, and the remaining consonants may be presented in the other sub-alphabet region. Further, the vowels and consonants sub-alphabet regions may be positioned relative to one another in a way that minimizes and/or optimizes a distance between a frequently-used consonant and a vowel (and/or aggregate distances between frequently-used consonants and vowels). The distance between consonants and vowels may be optimized by putting them close together, but not so close that the selection of the consonant and vowel leads to errors. The consonant and vowel sub-alphabets may be spaced (e.g. statically and/or dynamically positioned) far enough apart to avoid errors (e.g., selection errors) when a user hops back and forth between the vowels and consonants sub-alphabet regions, for example. The virtual keyboard, virtual keys, and/or the sub-alphabet regions thereof (e.g., individually or collectively) may be aligned vertically. The virtual keyboard, the virtual keys, and/or the sub-alphabet regions thereof (individually or collectively) may be aligned horizontally.

According to an example, one or more characters such as numerals may be presented in one or more separate regions or virtual keys (e.g., numerals regions). The numerals region may be in a collapsed state when not active and in an expanded state when active such that in the expanded state, the numerals region comprises and/or presents for viewing and/or selection one or more numerals, and in the collapsed state, the numerals may not be viewable. The numerals region may be accessed and/or made active in a way that displays some representation thereof that may be enhanced by a user's gaze (e.g., as the user's gaze approaches the representation for the numerals region (e.g., where, in an example, the representation may be a dot “.” disposed adjacent to the other regions) the numerals region may transition to the expanded state to expose the numerals for selection);

Further, in an example, one or more characters such as symbols may be presented in one or more separate regions or virtual keys (e.g., symbols regions). The symbols region may be in a collapsed state when not active and in an expanded state when active, where in the expanded state, the symbols region comprises and/or presents for viewing and/or selection one or more symbols, and in the collapsed state, none of the symbols are viewable;

The symbols region may be accessed and/or made active in a way that displays some representation thereof that may be enhanced by a user's gaze (e.g., as the user's gaze approaches the representation for the symbols region (e.g., another dot “.” disposed adjacent to the other regions) the symbols region transitions to the expanded state to expose the symbols for selection); and According to one example, upper case letters or alternative characters may be presented to the user when the user's gaze stays (e.g., fixates) on corresponding lower case letters or characters.

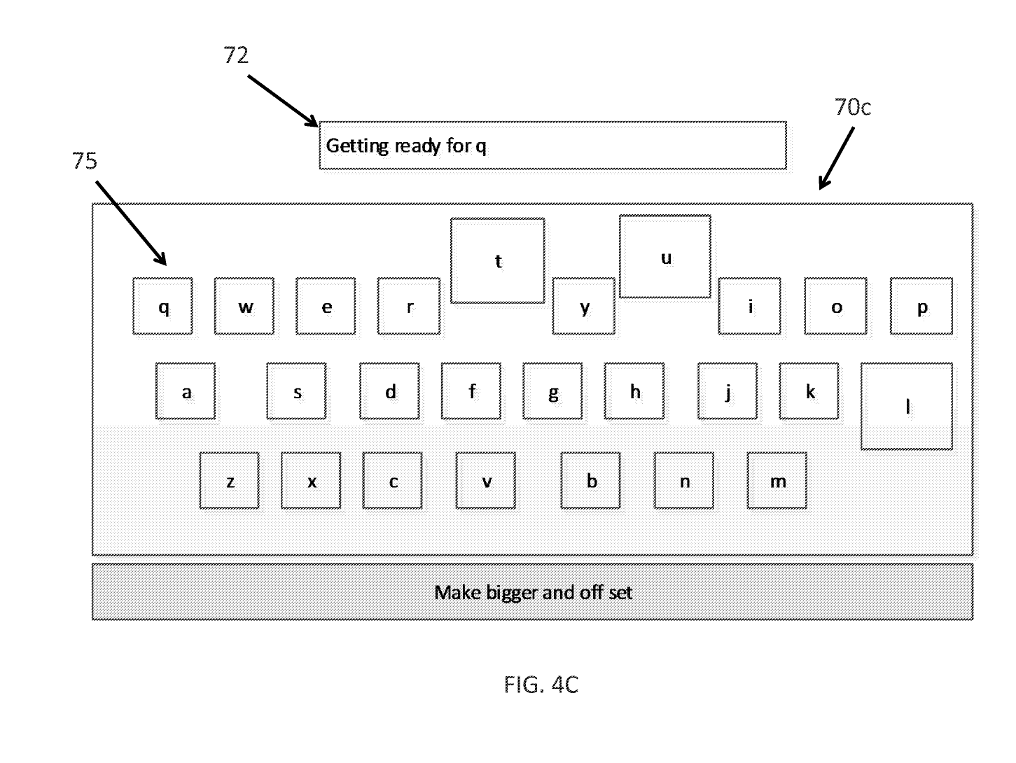

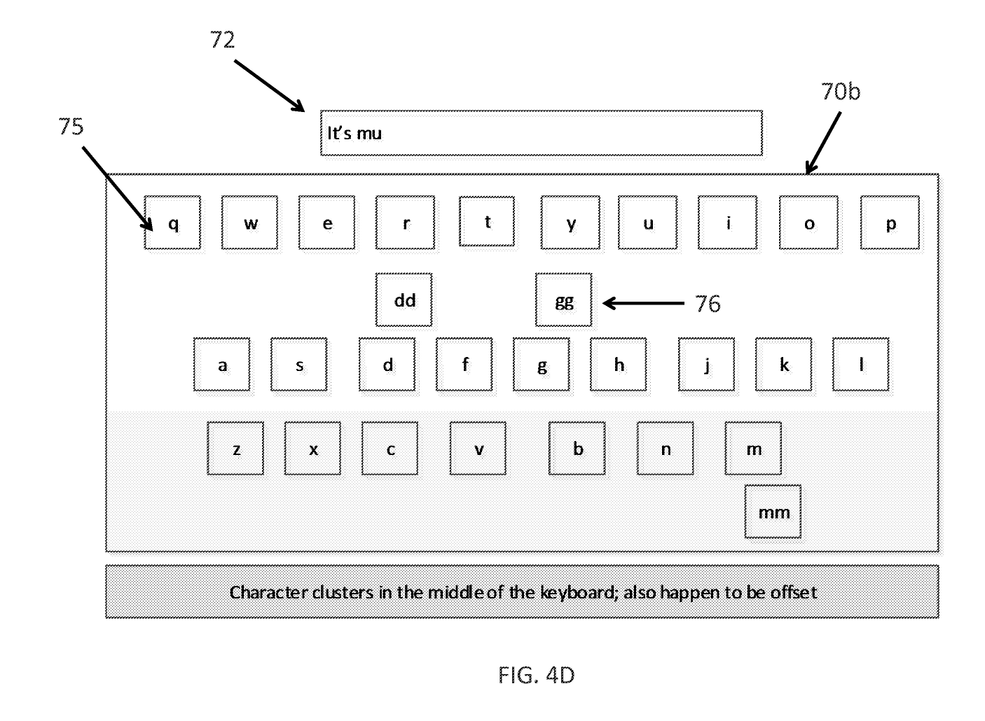

Additionally, in examples herein, a virtual keyboard having a virtual keyboard layout in accordance with one or more of the following features may be generated and/or provided. According to an example the virtual keyboard may be generated and/or provided by a text controller (e.g., text controller 16 in FIG. 1). The virtual keyboard layout may include a set of virtual keys. In an example, the set of virtual keys may include a corresponding set of characters likely to be used next by a user of the virtual keyboard. For example (e.g., as shown in FIG. 4D, for example), a character may be associated with each virtual key and/or multiple characters or character clusters may be associated with each virtual key where the characters and/or multiple characters or character clusters may be in the set of characters. The set of characters may include one or more characters (e.g., consonants, vowels, symbols, and/or the like) that may be selected based on a distribution of words in a dictionary selected using on one or more criteria. For example, the set of characters may have at least a portion of the characters represented on the virtual keys determined or selected based on a distribution of words. In an example, the distribution of words may be based on a dictionary. The dictionary may be selected using one or more criterion or criteria. The criteria may include at least one of the following: a system language that may be configured by the user (e.g., including jargon or language used by a user or typically used by a user) or one or more previously used characters, words or text in an application such as any application on the device and/or an application currently in use. In examples herein, the system language that may be configured by the user may be determined by identifying a language in which the user may be working based on at least one of the following: captured characters, words or text entered by the user, characters, words, or text the user may be reading or responding to, a language detector, and/or the like.

Display characteristics of at least a portion of the set of virtual keys of the virtual keyboard layout may be altered (e.g., emphasized) based on a probability of the one or more characters of the corresponding virtual keys being used next by the user of the virtual keyboard. The probability may include a twenty percent or greater chance of the one or more characters being used next by the user. In an example, the portion of the set of virtual keys may include at least one key for each row. The at least one key for each row may comprise a key from the set of virtual keys associated with a character from the set of characters having a greatest probability from the probability associated with the one or more characters of being used next by the user.

Further, in an example, the display characteristics of the at least the portion of the set of virtual keys may be altered by one or more of the following: increasing a width of a virtual key or a corresponding character included in the virtual key or increasing a height of the virtual key, or moving the key in a given direction (up, down, left, or right), or the corresponding character included in the virtual key or the luminance of the color, or the contrast of the color, or the shape of the virtual key. The width of the virtual key or the corresponding character may be increased up to fifty percent compared to other virtual keys or the corresponding characters in the set of virtual keys and the corresponding set of virtual characters. According to an example, the other virtual keys and the corresponding characters in a row with the virtual key are the corresponding character may be offset from the virtual key and the corresponding character (e.g., as shown in FIGS. 4A-4D in an example).

In one or more examples herein, the height of the virtual key or the corresponding character included in the virtual key may be increased up to fifty percent compared to other virtual keys or the corresponding characters in the set of virtual keys and the corresponding set of virtual characters. The height of the virtual key or the corresponding character may be increased in a particular direction depending on which row the virtual key or the corresponding character may be included. According to an example, the at least the portion of the set of virtual keys for which the display characteristics may be altered may include each virtual keys in the set of the virtual keys.

The display characteristics of each virtual keys that may be altered may be based on a grouping or bin to which each virtual key belongs to. For example, the virtual keys may be grouped or put into bins or groupings. The grouping or bin may include or have a range of probabilities associated therewith. The grouping or bin to which each virtual key belongs may be based on the probability associated with each virtual key being within the range of probabilities. In an example, the virtual keys or the corresponding characters in a grouping or bin having the virtual keys with higher probabilities within the range of probabilities of being used next may be altered more than the virtual keys or the corresponding characters in a grouping or bin having the virtual keys with higher probabilities within the range of probabilities of being used next.

In examples herein, the display characteristics of the one or more characters (e.g., all of the characters) may be altered, for example, using groupings or bins by determining the probability of selection of each character; sorting the characters into a preset number of character-size bins such as small, medium, large, and/or the like where large may include the top most likely third of the alphabet, medium may include the middle most likely third of the alphabet, and/or small may include the bottom most likely third of the alphabet; and/or adjusting or making the width and height of each character dependent on the bin it may belong to. According to examples herein, the width and/or height may be adjusted or made dependent on the bin it may belong to by, for example, assigning a preset proportion of sizes to small, medium, large, and/or the like (e.g., such as 1:2:4 for visible area), determining a maximum size for a small character based on the characters and their bins that may occur on each row and selecting the row that may have the largest area for characters (e.g., characters may be small enough that they fit on the row that has the most area (e.g., because it has more numerous and larger characters)), aligning the baseline for the characters that occur in a row and/or aligning the centering the characters that occur in a row, and/or setting the space between rows to accommodate large characters.

The virtual keyboard using the virtual keyboard layout including the altered display characteristics of the portion of the set of virtual keys may be displayed and/or output to a user via the device such that the user may interact with the virtual keyboard including the virtual keyboard layout including the altered display characteristics to enter text. As described herein, in an example, the virtual keyboard layout may be generated and/or modified (e.g., including the display characteristics) after a user may select a character. For example, upon entering text or a character that may be included in a word, a different or another virtual keyboard layout may be generated as described herein that may emphasize other characters and/or virtual keys likely to be used next by the user to complete the word or text, for example.

Additionally, in examples, data entry, via a user interface displayed on a device, using a virtual keyboard adapted to present an alphabet, may be provided as described herein. For example, a virtual keyboard layout may be generated (e.g., by a text controller such as text controller 16 in FIG. 1). The virtual keyboard layout may include a set of virtual keys. The set of virtual keys may include a corresponding set of characters or character clusters likely to be used next by a user of the virtual keyboard. The set of characters or character clusters may include one or more characters selected based on a distribution of words or characters (e.g., as described herein based on on frequently used words of a user, characters already entered and associated with text or a word being entered by a user, jargon of a user, information and/or traits associated with a user such as his or her job, information and/or traits associated with multiple users, and/or the like). The virtual keyboard may be displayed, for example, on the device such as on a display of the device using the virtual keyboard layout.

In examples herein, the distribution of words may be determined using a dictionary. The dictionary may be configured to be selected using one or more criteria. The criteria may include at least one of the following: a system language configured by the user or one or more previously used characters, or words or text in an application such as any application on the device and/or an application currently in use. According to an example, the system language may be configured by the user may be determined by identifying a language in which the user may be working based on at least one of the following: captured characters, words or text entered by the user, characters, words, or text the user may be reading or responding to, a language detector, and/or the like. Further, in examples herein, the distribution of words may be determined using entry of words or text in the application or text box associated therewith and/or a frequency of the words or the one or more characters being used by the user.

According to an example (e.g., to provide additional virtual keys in a keyboard layout (e.g., as shown in FIG. 4D with the character clusters)), whether space for one or more additional rows may be available in the virtual keyboard layout of the virtual keyboard may be determined (e.g., by a text controller as described herein). For example, such a determination may include whether there may be space for a certain number of additional rows (e.g., R rows) in a virtual keyboard and/or the virtual keyboard layout associated therewith. According to an example, in a typical three-row QWERTY keyboard, a determination may be made that there may be space for one or more (e.g., two) additional rows.

Further, one or more character clusters that may be frequently occurring or likely to be used next by the user may be determined based on at least one of the following: a dictionary, text entry by the user (e.g., in general over use and/or text entered so far), or text entry of a plurality of users. In an example, for each of the determined character clusters frequently occurring or likely to be used next by the user, at least a subset of the character clusters (e.g., three most frequently used characters clusters that may begin with a particular character) may be selected or chosen. The virtual keyboard layout may be altered to include the at least the subset of character clusters.

According to an example, selecting the at least the subset of the character clusters may include (e.g., the text controller may select the at least a subset of the character cluster by) one or more of the following: grouping the character clusters by the one or more additional rows; determining a number of the virtual keys associated with the character clusters that may be available to be included in the one or more additional rows (e.g., which may be based on a keyboard type, for example, as a rectangular keyboard and/or associated keyboard layout may have equal rows and/or in a QWERTY keyboard and/or associated keyboard layout lower rows or rows at a bottom of the keyboard may be smaller); determining a sum of the frequency for each of the character clusters for potential inclusion in the one or more additional rows (e.g., calculate the sum of frequencies for the clusters in each row in view of or based on (e.g., which may be limited by) the number of key that may be available such that the top clusters may be taken or determined to estimate the potential value of a row of character clusters that may be included in the keyboard layout); determining the at least the subset of character clusters with a highest combined frequency based on the sum; and/or selecting the at least the subset of character clusters based on the highest combined frequency and the number of the virtual keys that are available to be included in the one or more additional rows. Additionally, in examples (e.g., to select at least the subset of character clusters), the additional rows (e.g., top R rows) of character clusters may be selected or that may be selected may be further processed and/or, for example, for each row, the character clusters in the row (e.g., the additional rows) may be processed or considered for inclusion in decreasing frequency. For example (e.g., for each row or additional row), for each character cluster (or even character), there may be a number of slots (e.g., three slots) available in the additional row that may be generated or constructed (e.g., added). In an example, these slots maybe horizontally offset from one or more of the other characters or character clusters (e.g., they may be offset to the left, to the right, and/or not at all). Further, according to an example, the slots of two adjacent characters or character clusters may overlap (e.g., a d's right slot overlaps f s left slot; however, the middle slot for each character may be safe or may stay the same). The character clusters may be placed or may be provided in a slot for their first character provided such a slot may be available as described herein. Such a processing of the subset of character clusters in order of decreasing frequency (e.g., for selecting the subset of the character clusters to including in the virtual keyboard and/or generate in the virtual keyboard layout) may end, for example, when there no more clusters in the row of character clusters and/or there may be no more matching slots for the character cluster. The additional row may be processed (e.g., again) such that character clusters for the same character may be sorted alphabetically (e.g., to make sure that sk places to the left of st, and/or the like)

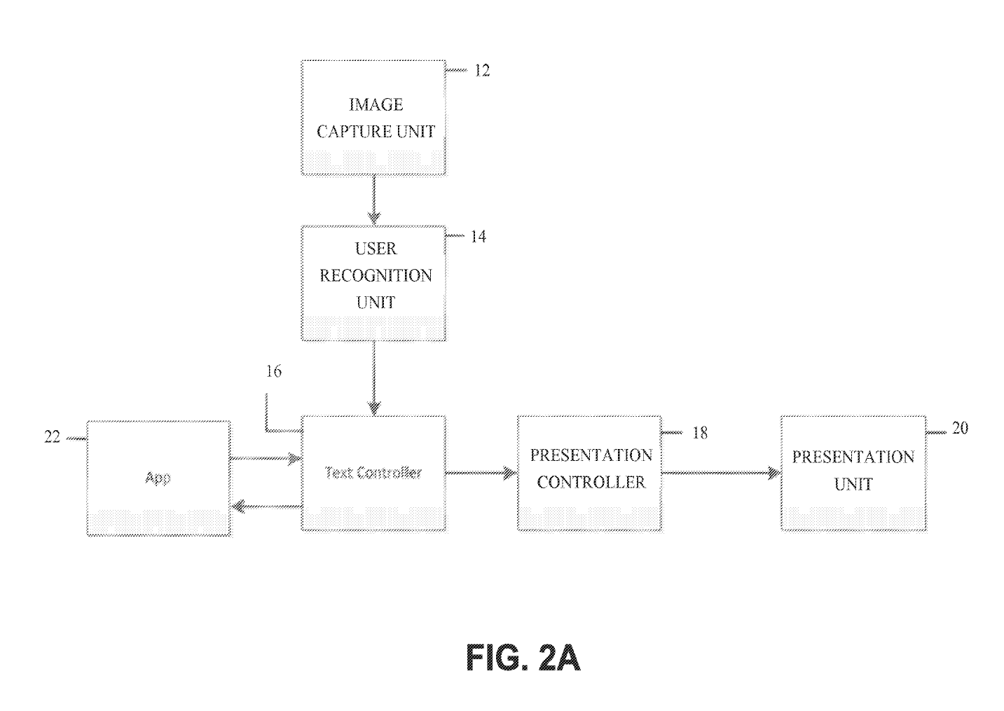

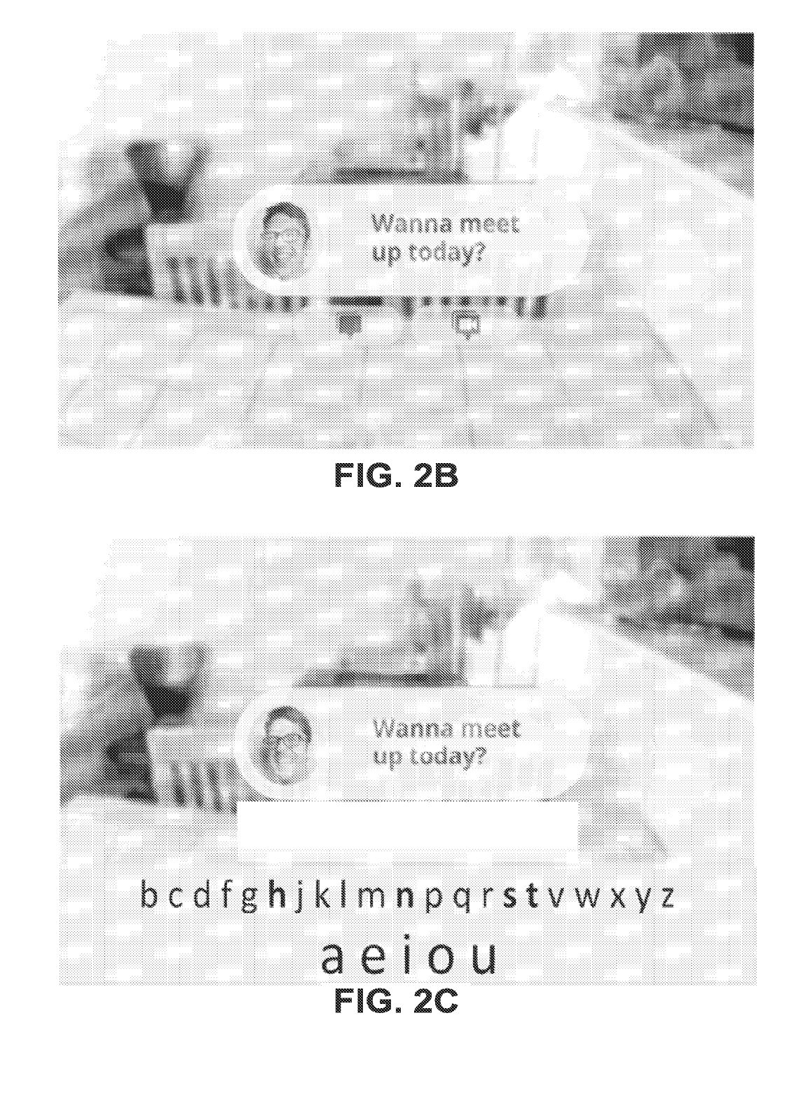

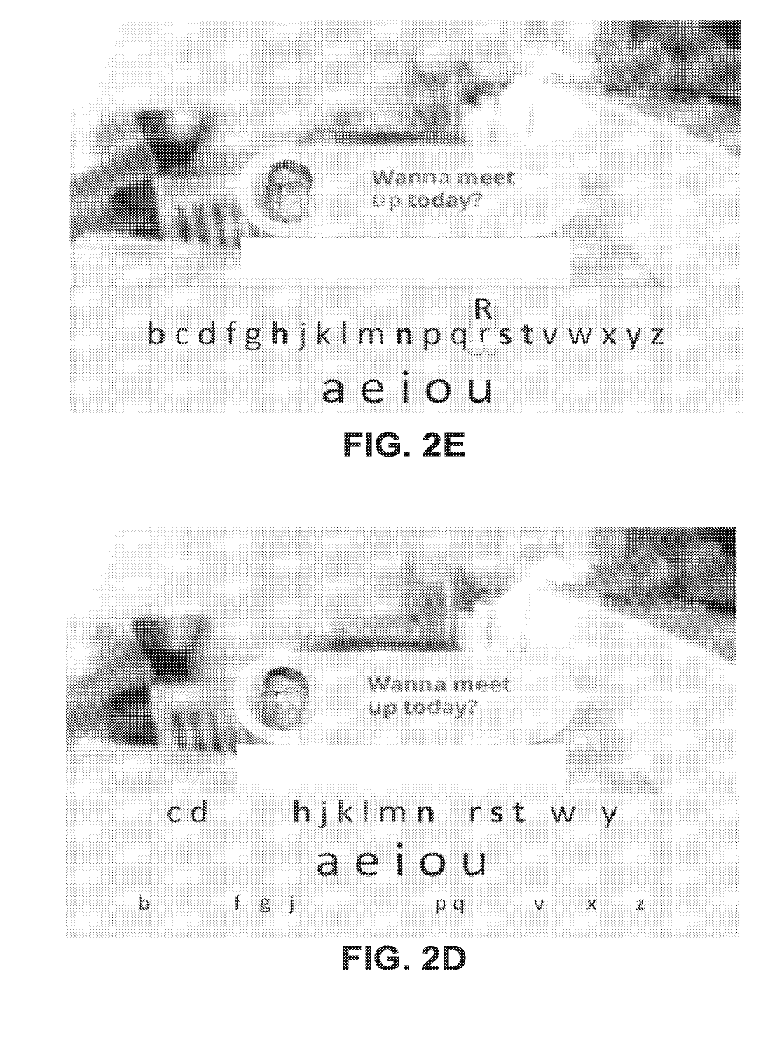

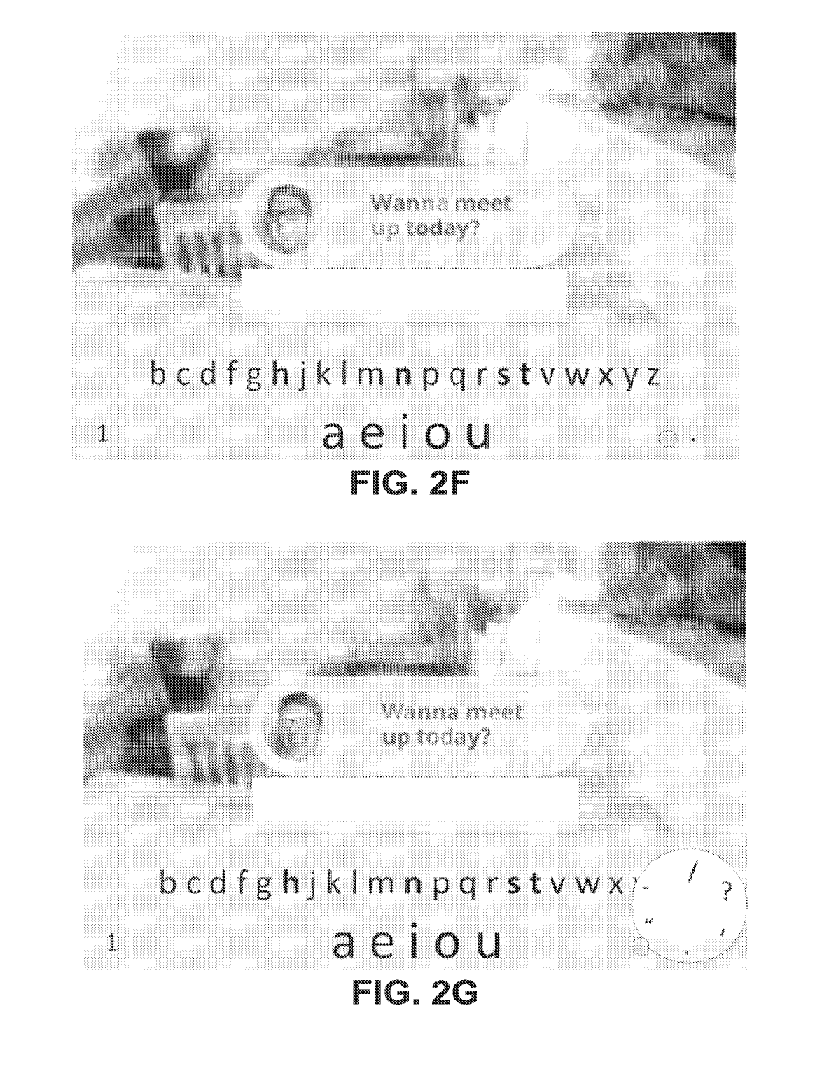

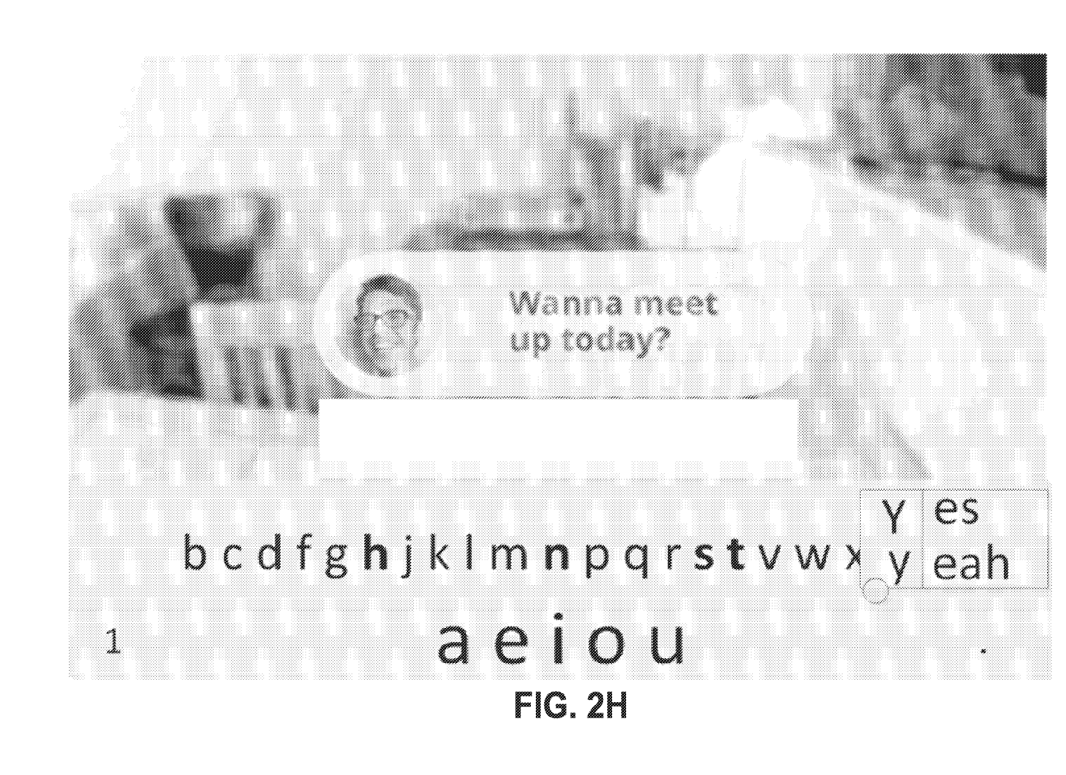

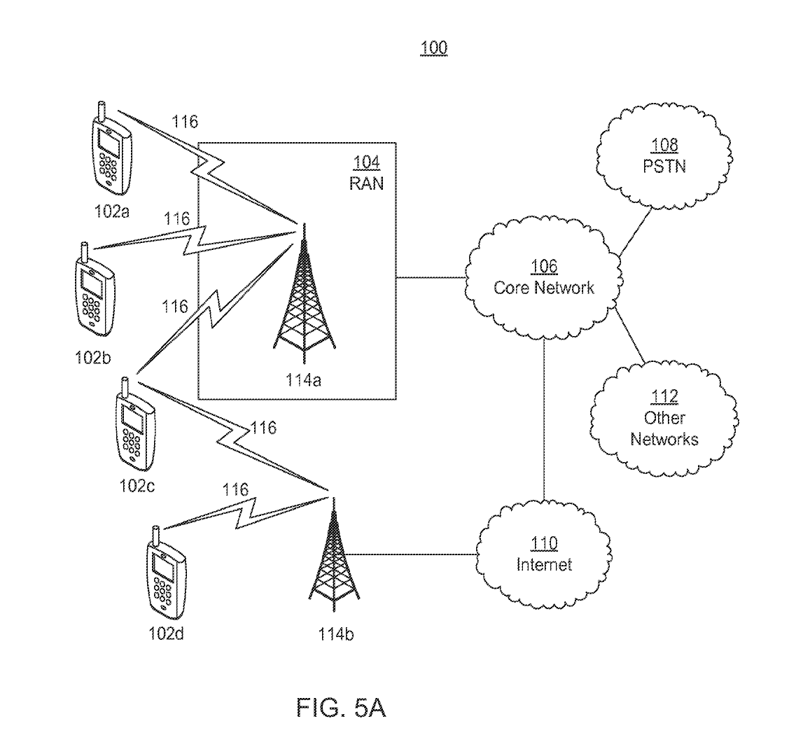

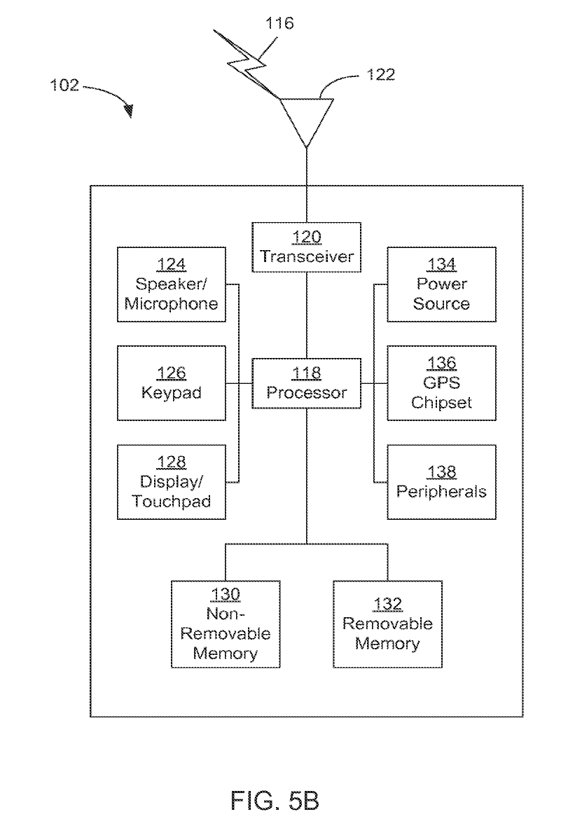

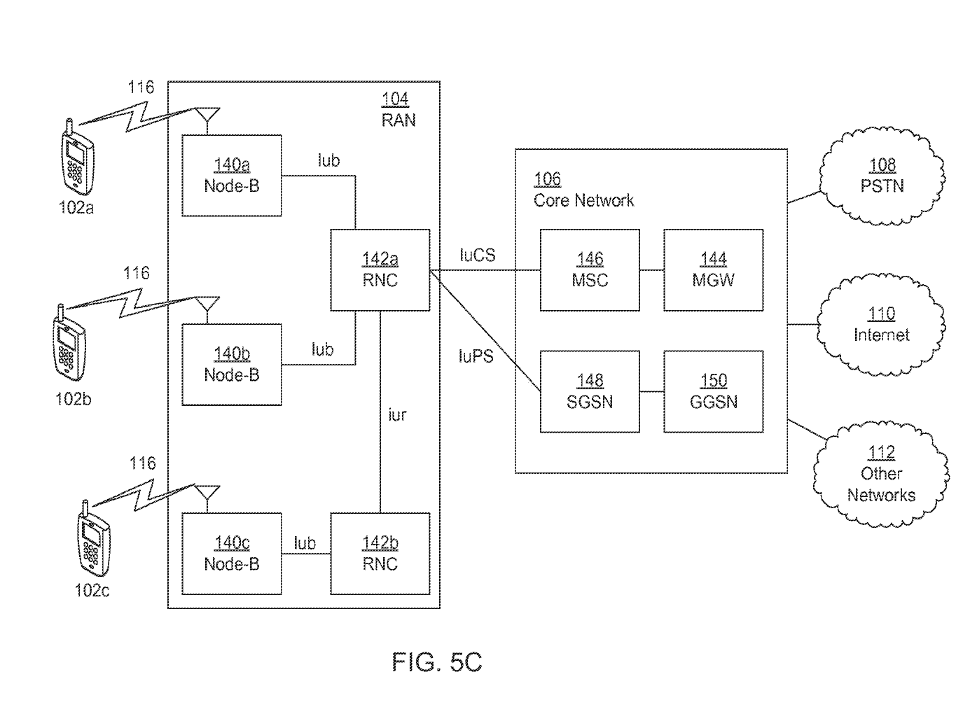

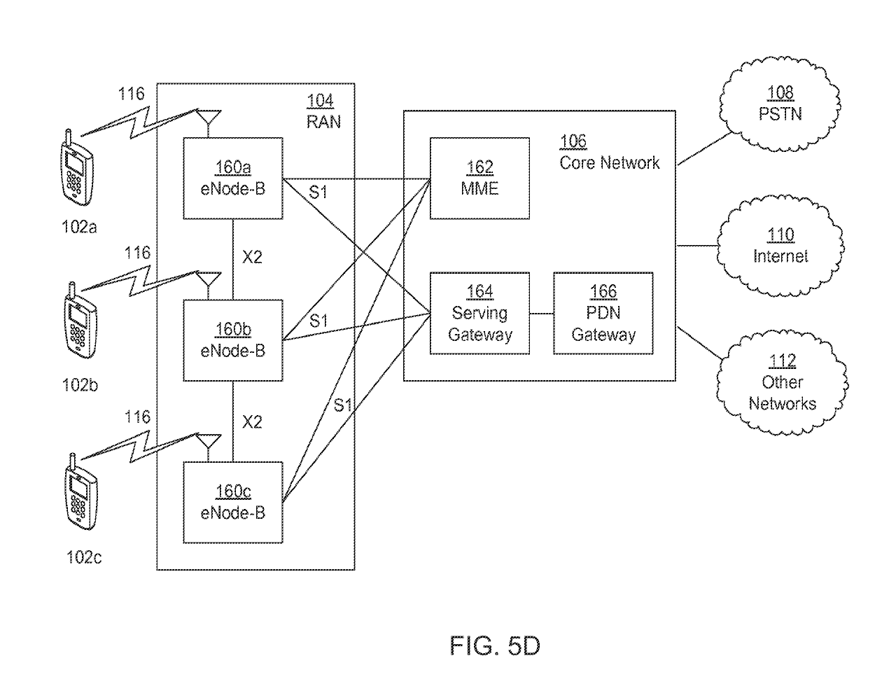

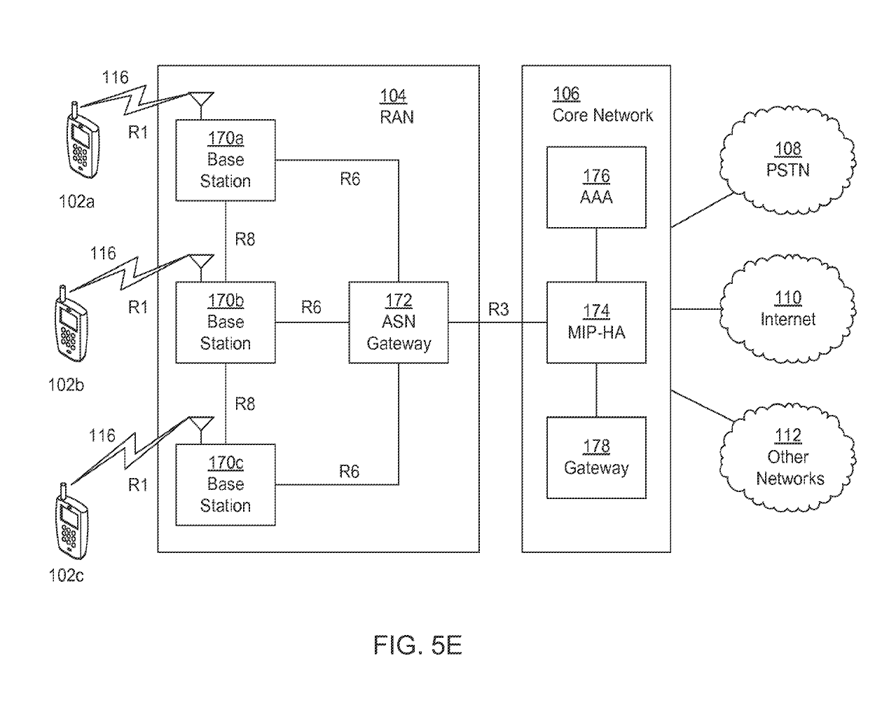

FIG. 2A depicts a block diagram illustrating an example of a system in which one or more disclosed embodiments may be implemented. The system may be used, implementable, and/or implemented in a device. As used herein, the device may include and/or may be any kind of device that can receive, process and present (e.g., display) information. In various examples, the device may be a wearable device such as smart glasses or a smart watch; a smartphone; a wireless transmit/receive unit (WTRU) such as described with reference to FIGS. 5A-5E; another type of user equipment (UE), and/or the like. Other examples of the device may include a mobile device, personal digital assistant (PDA), a cellular phone, a portable multimedia player (PMP), a digital camera, a notebook, and a tablet computer, a vehicle navigation computer (e.g., with a heads-up display). In general, the computing device includes a processor-based platform that operates on a suitable operating system, and that may be capable of executing software.

The system (e.g., that may be implemented in the device) may include an image capture unit 12, a user-recognition unit 14, a text controller 16, a presentation controller 18, a presentation unit 20 and an application 22. The image capture unit 12 may be, or include, any of a digital camera, a camera embedded in a mobile device, a head mounted display (HMD), an optical sensor, an electronic sensor, and/or the like. The image capture unit 12 may include more than one image sensing device, such as one that may be pointed towards or capable of sensing a user of the computing device, and one that may be pointed towards or capable of capturing real-world view.

The user input recognition unit 14 may recognize user inputs. The user input recognition unit 14, for example, may recognize user inputs related to the virtual keyboard. Among the user inputs that the user input recognition unit 14 may recognize may be a user input that may be indicative of the user's designation or a user expression of designation of a position (e.g., designated position) associated with one or more characters of the virtual keyboard. Also among the user inputs that the user input recognition unit 14 may recognize may be a user input that may be indicative of the user's interest or a user expression of interest (e.g., interest indication) in one or more of the characters of the virtual keyboard.

The user input recognition unit 14 may recognize user inputs provided by one or more input device technologies. The user input recognition unit 14, for example, may recognize the user inputs made by touching or otherwise manipulating the presentation unit 20 (e.g., by way of a touchscreen or other like type device). Alternatively or additionally, the user input recognition unit 14 may recognize the user inputs captured by the image capture unit 12 and/or another image capture unit by using an algorithm for recognizing interaction between a finger tip of the user captured by a camera and the presentation unit 20. Such algorithm, for example, may be in accordance with the Handy Augmented Reality method. The user input recognition unit 210 may further use algorithms other than the Handy Augmented Reality method.

As another or additional example, the user input recognition unit 14 may recognize the user inputs provided from an eye-tracking unit (not shown). In general, the eye tracking unit may use eye tracking technology to gather data about eye movement from one or more optical sensors, and based on such data, track where the user may be gazing and/or may make user input determinations based on various eye movement behaviors. The eye tracking unit 14 may use any of various known techniques to monitor and track the user's eye movements.

For example, the eye tracking unit may receive inputs from optical sensors that face the user, such as, for example, the image capture unit 12, a camera (not shown) capable of monitoring eye movement as the user views the presentation unit 20, or the like. The eye tracking unit may detect or determine the eye position and the movement of the iris of each eye of the user. Based on the movement of the iris, the eye tracking unit may determine or make various observations about the user's gaze. For example, the eye tracking unit may observe saccadic eye movement (e.g., the rapid movement of the user's eyes), and/or fixations (e.g., dwelling of eye movement at a particular point or area for a certain amount of time).

The eye tracking unit may generate one or more of the user inputs by employing an inference that a fixation on a point or area (e.g., a focus region) on the screen of the presentation unit 20 may be indicative of interest in a portion of the display and/or user interface, underlying the focus region. The eye tracking unit, for example, may detect or determine a fixation at a focus region on the screen of the of the presentation unit 20 mapped to a designated position, and generate the user input based on the inference that fixation on the focus region may be a user expression of designation of the designated position.

The eye tracking unit may also generate one or more of the user inputs by employing an inference that the user's gaze toward, and/or fixation on a focus region corresponding to, one or more of the characters depicted on the virtual keyboard may be indicative of the user's interest (or a user expression of interest) in the corresponding characters. The eye tracking unit, for example, may detect or determine the user's gaze toward an anchor point associated with the numerals (or symbols) region, and/or fixation on a focus region on the screen of the of the presentation unit 20 mapped to the anchor point, and generate the user input based on the inference may be a user expression of interest in the numerals (or symbols) region.

The application 22 may determine whether a data (e.g., text) entry box may be or should be displayed. In an example (e.g., if the application 22 may determine that the data entry box should be displayed), the application may request input from the text controller 16. The text controller 16 may provide the application 22 with relevant information. This information may include, for example, where to display the virtual keyboard (e.g., its position on the display of the presentation unit 20); constraints on, and/or options associated with, data (e.g., text) to be entered, such as, for example, as whether the data (e.g., text) to be entered may be a date field, an email address, etc.; and/or the like.

The text controller 16 may determine the presentation of the virtual keyboard. The text controller 16, for example, may select a virtual keyboard layout from a plurality of virtual keyboard layouts maintained by the computing device. The virtual keyboard layout may include one or more virtual keys that may have one or more corresponding characters (e.g., a set of characters) associated therewith. For example, if the data to be entered may be an email address the virtual keyboard may have “.”, “@”, “com” available on the keyboard. However, if the data to be entered may be a date then “-”, “I” may be available as a sub-alphabet on the keyboard rather than under an anchor point.

Alternatively or additionally, the text controller 16 may generate the virtual keyboard layout based on a set of rules (e.g., rules with respect to presenting the consonant and vowels sub-alphabet regions and/or other regions). The rules, for example, may specify how to separate the characters into consonants, vowels, and so on.

Further, in examples, the text controller 16 may generate the virtual keyboard layout (e.g., with the virtual keys and/or corresponding characters or sets of characters or character clusters (e.g., sc, sk, sr, ss, st, and/or the like)) based on a distribution of words or characters. According to an example, the distribution of words may be based on a dictionary that may be selected using one or more criterion or criteria and/or jargon or typical phrases of a user (e.g., frequency of words, letters, symbols, and/or the like used, for example, by a user). The criteria and/or criterion may include a system a system language that may be configured by the user or one or more previously used characters, words or text in an application (e.g., any application on the device and/or an application that may be currently in use on the device). According to an example, the system language that may configured by the user may be determined by identifying a language in which the user may be working based on at least one of the following: captured characters, words or text entered by the user, characters, words, or text the user may be reading or responding to, a language detector, and/or the like.

The virtual keyboard layout selected and/or generated (and/or one or more of the virtual keyboard layouts) may facilitate presentation of the consonant and vowels sub-alphabet regions and/or other regions and/or the virtual keys. The text controller 16 may generate configuration information (e.g., parameters) for formatting, and generating presentation of, the virtual keyboard. This configuration information may include information to emphasize one or more of the characters or virtual keys of the virtual keyboard. In an example, the emphasis may be based (e.g., the display characteristics of the virtual keys of the virtual keyboard and/or the corresponding characters associated therewith may be altered) a probability a character (e.g., the one or more characters from the set of characters) being used next by a user of the virtual keyboard (e.g., a user of the device interacting with the virtual keyboard). The text controller 16 may provide the virtual keyboard layout and corresponding configuration information to the presentation controller 18.

The presentation controller 18 may, based at least in part on the virtual keyboard layout and configuration information, translate the virtual keyboard layout into the virtual keyboard for presentation via the presentation unit 20. The presentation controller 18 may provide the virtual keyboard, as translated, to the presentation unit 20.

The presentation unit 20 may be any type of device for presenting visual and/or audio presentation. The presentation unit 20 may include a screen of a computing device. The presentation unit 20 may be (or include) any type of display, including, for example, a windshield display, wearable computer (e.g., glasses), a smartphone screen, a navigation system, etc. One or more user inputs may be received by, through and/or in connection with user interaction with the presentation unit 20. For example, a user may input a user input or selection by and/or through touching, clicking, drag-and-dropping, gazing at, voice/speech recognition, gestures, and/or other interaction in connection with the virtual keyboard presented via the presentation unit 20.

The presentation unit 20 may receive the virtual keyboard from the presentation controller 18. The presentation unit 20 may present (e.g., display) the virtual keyboard.

FIGS. 2B-2H depict example interfaces or displays of a user interface of an application executing on a device such as the device described herein that may implement the system shown in FIG. 2A. In examples herein, the displays of FIGS. 2B-2H may be described with respect to the system of FIG. 2A, but may be applicable and/or used in other systems or devices.

According to an example (e.g., as shown), the application 22 may be a messaging application. In general, the application 22 may be an application in which data entry may be made via the user interface by way of a virtual keyboard (e.g., virtual keyboard 30). The displays of FIGS. 2B-2H may illustrate examples of the virtual keyboard implemented and, for example, in use.

Referring to FIG. 2B, a user of the device (e.g., a wearable computer, such as, for example, smart glasses) sees a message from a friend pop up (e.g., within a field of view of the user of the wearable computer). The messaging application 22 may receive or obtain from the user input recognition unit 14 a user interest indication indicating the user wishes to respond to the received message. The messaging app 22 may determine the relevant alphabet (set of characters) from which the user may compose a response to the message (e.g., it could be the usual English alphabet or the English alphabet plus numerals and symbols).

The messaging application 22 may invoke or initiate the text controller 16. The text controller 16 may select a virtual keyboard layout from the plurality of virtual keyboard layouts maintained by the computing device, and generate the selected virtual keyboard layout for presentation. Alternatively, the text controller 16 may generate the virtual keyboard layout from the set of rules. The virtual keyboard layout may include first and second sub-alphabet regions (e.g., first sub-alphabet region 32a and second sub-alphabet region 32b as shown in FIG. 2C) positioned adjacent to each other. The first sub-alphabet region may be populated with only the consonants sub-alphabet. The second sub-alphabet region may be populated with only the vowels sub-alphabet. The text controller 16 may generate configuration information to emphasize frequently-used consonants.

The text controller 16 may provide the virtual keyboard layout and configuration information to the presentation controller 18. The presentation controller 18 may, based at least in part on the virtual keyboard layout and configuration information, translate the virtual keyboard layout into the virtual keyboard for presentation via the presentation unit 20. The presentation controller 18 may provide the virtual keyboard, as translated, to the presentation unit 20. The presentation unit 20 may receive the virtual keyboard from the presentation controller 18. The presentation unit 20 may present (e.g., display) the virtual keyboard. An example of such displayed virtual keyboard may be shown in FIG. 2C (e.g., the virtual keyboard 30 with the first and second sub-alphabet regions 32a, 32b). In an example, frequently-used consonants may be emphasized using bold text. For example, as shown in FIG. 2C, h, n, s, t may be emphasized such that the display characteristics thereof may be changed to bold text.

In examples, the virtual keyboard layout generated by the text controller 16 may include the first and second sub-alphabet regions along with a symbols region and a numerals region. The virtual keyboard layout may include a symbols-region anchor (e.g., a dot “.” disposed adjacent to the other regions) and/or a numerals-region anchor (e.g., another dot “.” disposed adjacent to the other regions). The symbols region may be anchored to the symbols-region anchor. The numerals region may be anchored to the numerals-region anchor.

The symbols region may be in a collapsed state when not active and in an expanded state when active, where in the expanded state, the symbols region comprises and/or presents for viewing and/or selection one or more symbols, and in the collapsed state, none of the symbols are viewable. The numerals region may be in a collapsed state when not active and in an expanded state when active, where in the expanded state, the numerals region comprises and/or presents for viewing and/or selection one or more numerals, and in the collapsed state, none of the numerals are viewable.

The text controller 16 may receive or obtain, for example, from the user input recognition unit 14, a user interest indication indicating interest in the numerals region (e.g., a user's gaze approaches the numerals-anchor point). The text controller 16 (e.g., in connection with the presentation controller 18 and/or the presentation unit 20) may activate the numerals region to make the numerals viewable and/or selectable. In certain representative embodiments, the text controller 16 may obtain from the user input recognition unit 14 a user input indicating a loss of interest in the numerals region (e.g., a user's gaze moves away from the numerals-anchor point). The text controller 16 (e.g., in connection with the presentation controller 18 and/or the presentation unit 20) may deactivate the numerals region to make it return to the collapsed state.

Alternatively and/or additionally, the text controller 16 may receiver or obtain from the user input recognition unit 14 a user interest indication indicating interest in the symbols region (e.g., a user's gaze approaches the symbols-anchor point). The text controller 16 (e.g., in connection with the presentation controller 18 and/or the presentation unit 20) may activate the symbols region to make the symbols viewable and/or selectable. In examples, the text controller 16 may receive or obtain from the user input recognition unit 14 a user input indicating a loss of interest in the symbols region (e.g., a user's gaze moves away from the symbols-anchor point). The text controller 16 (e.g., in connection with the presentation controller 18 and/or the presentation unit 20) may deactivate the symbols region to make it return to the collapsed state. FIGS. 2F and 2G illustrate a virtual keyboard having the first and second sub-alphabet regions along with symbols and numerals regions anchored to symbols-anchor and numerals-anchor points, respectively. As shown in FIG. 2F, both of the symbols and numerals regions (e.g., symbol region 36 and numeral region 38) may be in collapsed states. In FIG. 2G, the symbols regions (e.g., symbol region 36) may be in an expanded state responsive to a user interest indication indicating interest in the symbols region (e.g., the user's gaze approaches the symbols-anchor point).

According to one or more examples, the text controller 16 may receive or obtain from the user input recognition unit 14 a user interest indication indicating interest in a particular character (e.g., a user's gaze approaches and/or fixates the particular character). The text controller 16 (e.g., in connection with the presentation controller 18 and/or the presentation unit 20) may display adjacent to the particular character, and/or may make available for selection, an uppercase version, variant and/or alternative character of the particular character. In certain representative embodiments, the text controller 16 may receive or obtain from the user input recognition unit 14 a user input indicating a loss of interest in the particular character (e.g., a user's gaze moves away from the particular character). The text controller 16 in connection with the presentation controller 18 and/or the presentation unit 20 may not display, and/or make available for selection, the uppercase version, variant and/or alternative character of the particular character. FIG. 2E illustrates a virtual keyboard having the first and second sub-alphabet regions along with an uppercase version (e.g., 34) of the letter “r” displayed adjacent to the lowercase “r” and/or made available for selection.

In one or more examples, the text controller 16 may receive or obtain from the user input recognition unit 14, a user interest indication indicating interest in a particular character (e.g., a user's gaze approaches and/or fixates the particular character). The text controller 16 in connection with the presentation controller 18 and the presentation unit 20 may display adjacent to the particular character, and/or may make available for selection, one or more suggestions (e.g., words and/or word stems). Further, in an example, the text controller 16 may receiver or obtain from the user input recognition unit 14 a user input indicating a loss of interest in the particular character (e.g., a user's gaze moves away from the particular character). The text controller 16 in connection with the presentation controller 18 and the presentation unit 20 may not display, and/or make available for selection, the suggestions. FIG. 2H illustrates a virtual keyboard having the first and second sub-alphabet regions along with multiple suggestions displayed (e.g., 39), and/or made available for selection, in connection with the user interest in the letter “y”.

According to one or more examples, the virtual keyboard layout generated by the text controller 16 may include first and second sub-alphabet regions (e.g., first and second sub-alphabet regions 38a, 38b) positioned adjacent to each other, and a third sub-alphabet region (e.g., third sub-alphabet region 38c) positioned adjacent to, and separated from the first sub-alphabet region by, the second sub-alphabet region. The first sub-alphabet region may be populated with only frequently-used consonants of the consonants sub-alphabet. The second sub-alphabet region may be populated with only the vowels sub-alphabet. The third sub-alphabet region may be populated with the remaining consonants of the consonants sub-alphabet. The text controller 16 may generate configuration information to emphasize frequently-used characters. An example of a virtual keyboard formed in accordance with such virtual keyboard layout may be shown in FIG. 2D. As shown, the second (vowel) sub-alphabet region may be positioned between the first (frequently-used consonants) sub-alphabet region and the third (remaining consonants) sub-alphabet region. As shown, some of the frequently-used consonants in the first (frequently-used consonants) sub-alphabet region are emphasized using bold text.

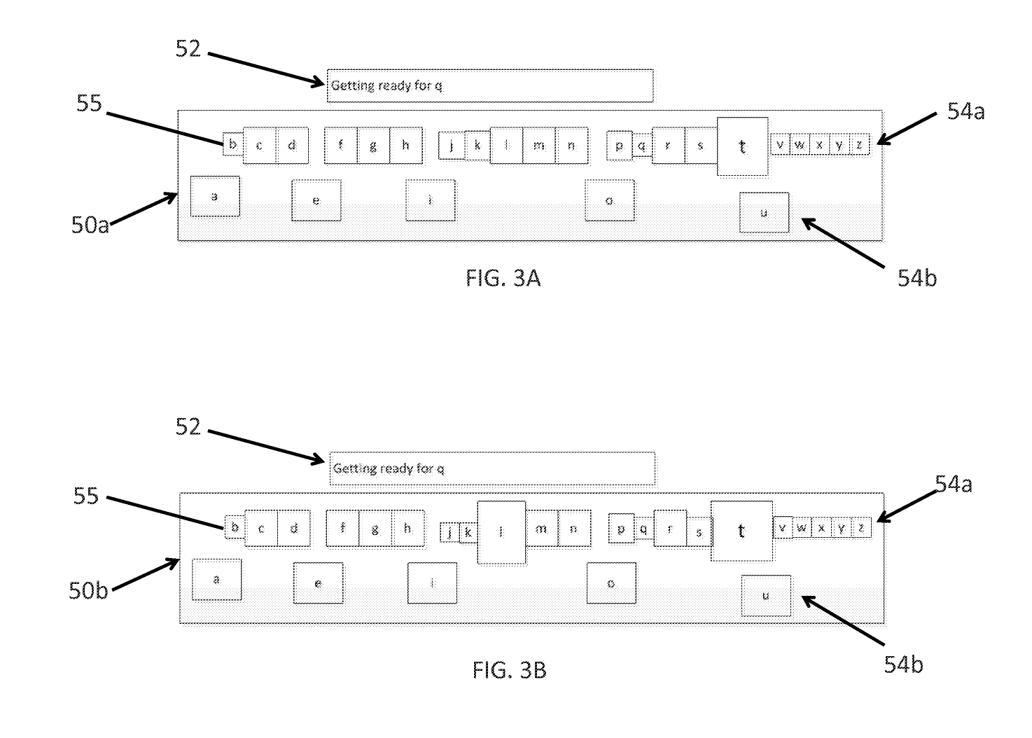

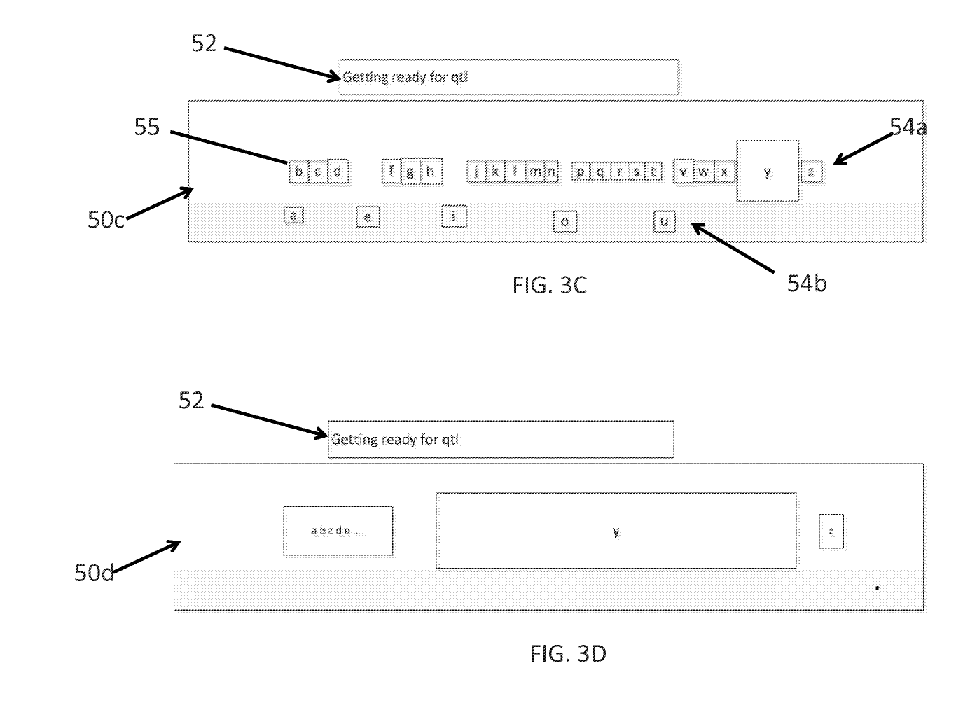

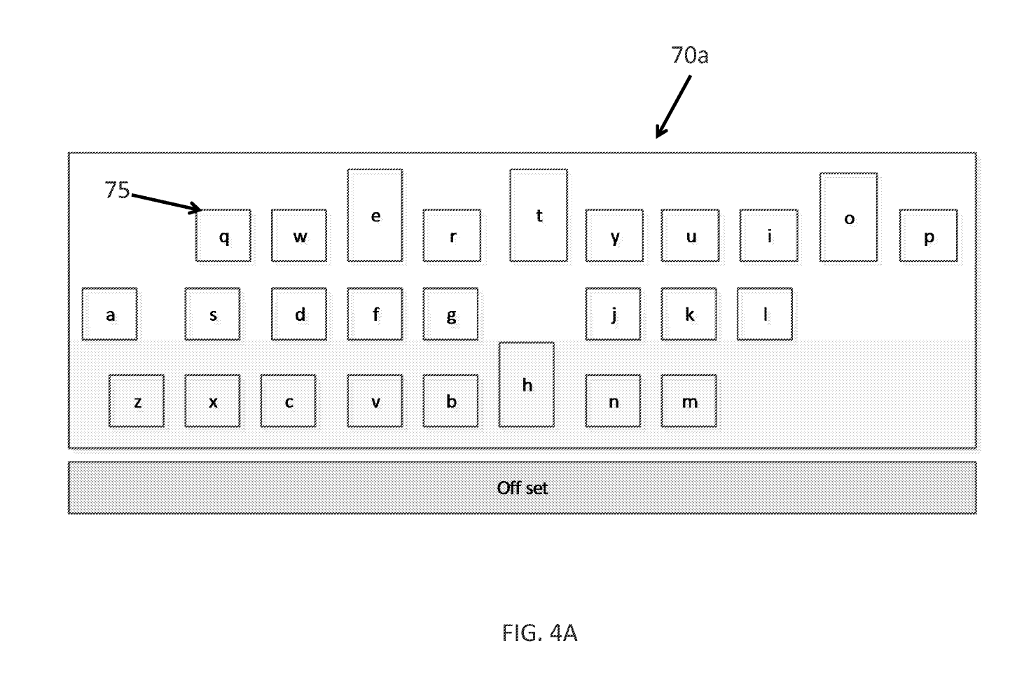

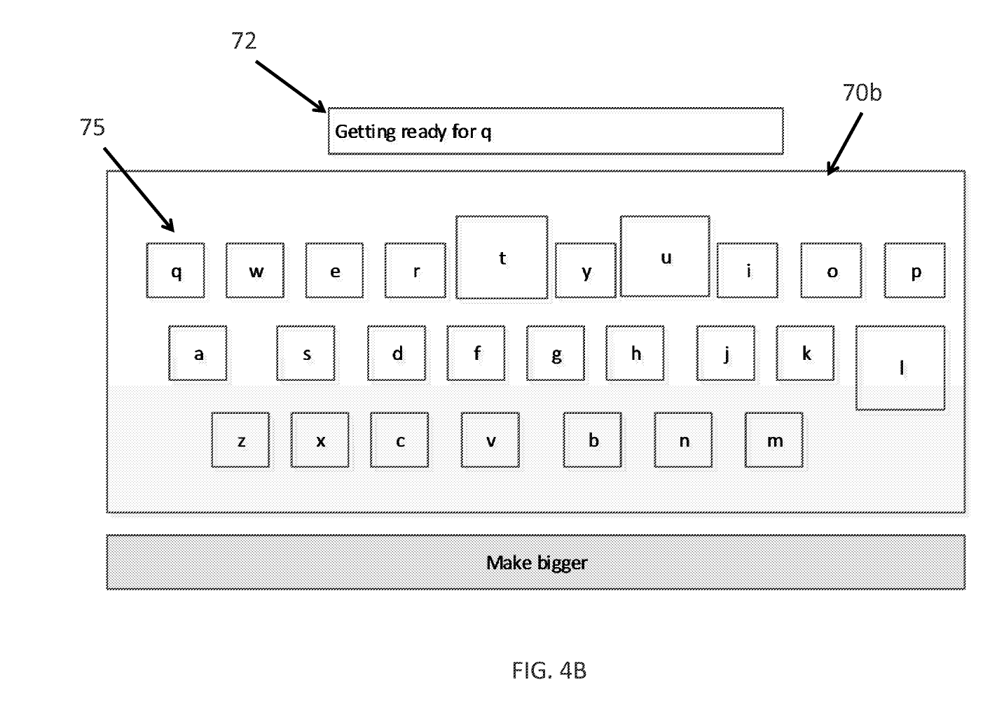

FIGS. 3A-3D depict example interfaces or displays of a user interface of an application executing on a device such as the device described herein that may implement the system shown in FIG. 2A. In examples herein, the displays of FIGS. 3A-3D may be described with respect to the system of FIG. 2A, but may be applicable and/or used in other systems or devices.

As shown in FIGS. 3A-3D, display characteristics or features of one or more virtual keys and/or corresponding characters or character clusters associated therewith may be based on a frequency of use or occurrence in the application or application context and/or the user's history of text entry. For example, a user may be a business executive or employee that may use and/or may have in his or her vocabulary financial terms or words such as quarterly, guesstimate, mission-critical, monetize, and/or the like. The user may use the financial words or terms in a messaging application and/or a word processing application. According to an example, the business executive or employee (e.g., user) may be use a device and may abbreviate such words or terms. For example, the business executive or employee may abbreviate quarterly as qtly. As described herein, a virtual keyboard or keyboard may be provided that may alter display characteristics (e.g., emphasize the virtual keys and/or characters including increasing a font size and/or surface area as shown in FIGS. 3A-3D) one or more virtual keys and/or one or more characters or set of characters associated therewith in a virtual keyboard layout based on the one or more characters being likely to be used or selected next by a user such as the business executive or employee.

In an example, as shown in FIGS. 3A-3D, the application 22 may be an application in which data entry may be made via the user interface by way of a virtual keyboard (e.g., virtual keyboard 50a-d) that may have a virtual keyboard layout associated therewith or corresponding thereto. The displays of FIGS. 3A-3D may illustrate examples of the virtual keyboard implemented and, for example, in use.

Referring to FIG. 2B, a user of the device (e.g., a wearable device or computer such as, for example, smart glasses) may input text such as “Getting ready for q” in a text box (e.g., text box 52). The text box, in an example, may be within a field of view of the user of the device. According to an example, an indication to enter or input text in the text box may be received and/or processed by the user input recognition unit 14 (e.g., the user input recognition unit may recognize eye movement and/or gazes that may select one or more virtual keys with corresponding characters to enter in the text box). The application 22 may receive or obtain from the user input recognition unit 14, a user interest indication indicating the user may wish to input text in the text box. The application 22 may determine a relevant alphabet (e.g., set of characters) from which the user may input text (e.g., it could be the usual English alphabet or the English alphabet plus numerals and symbols).

According to an example, the application 22 may invoke or initiate the text controller 16. The text controller 16 may determine or select a virtual keyboard layout (e.g., as shown in FIGS. 3A-3D) for a virtual keyboard (e.g., virtual keyboard 50a-d) and/or may generate the selected virtual keyboard layout for presentation. In an example, the virtual keyboard layout may be selected or determined from a plurality of virtual keyboard layouts maintained by the device. Alternatively or additionally, the text controller 16 may generate the virtual keyboard layout from the set of rules. The virtual keyboard layout may include first and second sub-alphabet regions (e.g., the first sub-alphabet region 54a and the second sub-alphabet region 54b) that may be positioned near adjacent to each other. The first and/or second sub-alphabet regions may include one or more virtual keys or a set of virtual keys (e.g., as shown by virtual key 55). The virtual keys may have a set of characters associated therewith (e.g., one or more characters as shown by virtual key 55 that may include the character b). As shown, in an example, the first sub-alphabet region may be populated with the consonants sub-alphabet. The second sub-alphabet region may be populated with the vowels sub-alphabet. The text controller 16 may generate emphasize frequently-used characters and/or virtual keys and/or characters and/or virtual keys likely to be used next (e.g., based on text in the text box 52 and/or a probability of a subsequent character being selected as described herein such as based on words frequently used by a user such as the financial executive). For example, as shown in FIGS. 3A-3D, virtual keys with characters u, t, and/or 1 (e.g., and subsequently when additional text may be entered y as shown in FIG. 3D) may be larger or enlarged (e.g., may have their display characteristics altered) to enlarge them such that an emphasis may be put on these virtual keys and/or characters corresponding thereto as it may be likely they may be selected by a user to complete the abbreviation qtly and/or the word quarterly. In an example, information such as configuration information may be used to determine which virtual keys and/or corresponding characters to emphasize.

As described herein, the text controller 16 may provide the virtual keyboard layout (e.g., and/or information or configuration information) to the presentation controller 18. The presentation controller 18 may, based at least in part on the virtual keyboard layout and emphasis or display characteristics to alter (e.g., which may be included in information or configuration information), may translate the virtual keyboard layout into the virtual keyboard for presentation via the presentation unit 20. The presentation controller 18 may provide the virtual keyboard, as translated, to the presentation unit 20. The presentation unit 20 may receive the virtual keyboard from the presentation controller 18. The presentation unit 20 may present (e.g., display) the virtual keyboard. An example of such displayed virtual keyboard may be shown in FIGS. 3A-3D. As shown, virtual keys and/or corresponding characters may be emphasized (e.g., their display characteristic may be altered by) using larger keys for particular characters that may be likely to be selected next by a user. According to an example, the virtual keys and/or corresponding characters may be emphasized based on input in the text box and/or a probability or likelihood of a character being selected next by a user, for example, based on such input as described herein (e.g., below).

According to one or more examples, the text controller 16 may receive or obtain from the user input recognition unit 14 a user interest indication indicating interest in a particular character (e.g., a user's gaze approaches and/or fixates the particular character). As shown, it may be characters that may be used to complete the abbreviation qtly. The text controller 16 (e.g., in connection with the presentation controller 18 and/or the presentation unit 20) may adjust the display characters of other virtual keys and/or the corresponding characters as the user beings to complete qtly by receiving the user interest indication of q, followed by t, followed by l, for example, and, subsequently, y. For example, as shown in FIG. 3D, the most likely character for a giver user in a context (e.g., to complete qtly) may be a Y. As such, target area for the virtual key associated with y and/or the character y in the virtual key may be increased while the target area for the rest of the alphabet may be compressed.

Additionally, in examples herein, the virtual keyboard layout may provide virtual keys and/or characters associated therewith (e.g., a set of characters) likely to be used or selected next by the user rather than an entire set of virtual keys and/or corresponding characteristics. For example, when qtl, y may be provided or entered, a virtual keyboard layout may be determined that may provide a y in a virtual key associated therewith and each of the other characters and/or virtual keys may be removed and/or compressed as shown in FIG. 3D. In an example, the text controller 16 may make such a determination of the virtual keyboard layout as described herein. Further, in examples, the virtual keys and/or a corresponding set of characters that may include one or more characters that may be likely to be used next by a user and, thus, presented in a virtual keyboard layout (e.g., that may be determined and/or generated by the text controller 16) may be based on a distribution of words in a dictionary selected using one or more criterion or criteria as described herein. Additionally, as described herein, display characteristics of at least a portion of those virtual keys and/or corresponding characters may be altered based on a probability (e.g., greater than or equal to 20% chance) of the characters being selected next as described herein (e.g., y may be enlarged and/or other characters compressed as shown in FIG. 3D based on a probability of greater than or equal to 20% chance of being selected next when viewed with the text qtl entered in the text box).

FIGS. 4A-4D depict example interfaces or displays of a user interface of an application executing on a device such as the device described herein that may implement the system shown in FIG. 2A. In examples herein, the displays of FIGS. 4A-4D may be described with respect to the system of FIG. 2A, but may be applicable and/or used in other systems or devices. As shown in FIGS. 4A-4B, examples herein may be applied to a QWERTY keyboard (e.g., 70a-d). For example, the virtual keyboard layout may be a QWERTY keyboard layout that may have display characteristics of one or more virtual keys and/or a set of corresponding characters (e.g., one or more corresponding characters) selected to be likely to be used next and/or altered as described herein).

As described herein, a user of the device (e.g., a wearable device or computer such as, for example, smart glasses) may input text such as “Getting ready for q” in a text box (e.g., text box 72). The text box, in an example, may be within a field of view of the user of the device. According to an example, an indication to enter or input text in the text box may be received and/or processed by the user input recognition unit 14 (e.g., the user input recognition unit may recognize eye movement and/or gazes that may select one or more virtual keys with corresponding characters to enter in the text box). The application 22 may receive or obtain from the user input recognition unit 14, a user interest indication indicating the user may wish to input text in the text box. The application 22 may determine a relevant alphabet (e.g., set of characters) from which the user may input text (e.g., it could be the usual English alphabet or the English alphabet plus numerals and symbols).

According to an example, the application 22 may invoke or initiate the text controller 16. The text controller 16 may determine or select a virtual keyboard layout (e.g., as shown in FIGS. 3A-3D) for a virtual keyboard (e.g., virtual keyboard 70a-d) and/or may generate the selected virtual keyboard layout for presentation. In an example, the virtual keyboard layout may be selected or determined from a plurality of virtual keyboard layouts maintained by the device. Alternatively or additionally, the text controller 16 may generate the virtual keyboard layout from the set of rules. The virtual keyboard layout may include virtual keys (e.g., at least a set of virtual keys or one or more virtual keys as shown by virtual key 75 that may include character q in FIGS. 4A-4D) that may be positioned near adjacent to each other. The virtual keys may include a set of characters (e.g., that may be likely to be used next by a user). The set of characters may include one or more characters selected based on a distribution of words in a dictionary. The dictionary may be selected using one or more criterion or criteria (e.g., previously used characters or words, a system language, words or text (e.g., including abbreviations such as qtly) commonly or frequently entered, input, or used by a user). The text controller 16 may generate emphasize frequently-used characters and/or virtual keys and/or characters and/or virtual keys likely to be used next (e.g., based on text in the text box (e.g., 72) and/or a probability of a subsequent character being selected as described herein such as based on words frequently used by a user such as the financial executive). For example, as shown in FIGS. 4B-4C, virtual keys with characters t, u, and 1 and y may be larger or enlarged (e.g., may have their display characteristics altered) and/or offset such that an emphasis may be put on these virtual keys and/or characters corresponding thereto as it may be likely they may be selected by a user to complete the abbreviation qtly and/or the word quarterly. In an example, information such as configuration information may be used to determine which virtual keys and/or corresponding characters to emphasize.

As described herein, the text controller 16 may provide the virtual keyboard layout (e.g., and/or information or configuration information) to the presentation controller 18. The presentation controller 18 may, based at least in part on the virtual keyboard layout and emphasis or display characteristics to alter (e.g., which may be included in information or configuration information), may translate the virtual keyboard layout into the virtual keyboard for presentation via the presentation unit 20. The presentation controller 18 may provide the virtual keyboard, as translated, to the presentation unit 20. The presentation unit 20 may receive the virtual keyboard from the presentation controller 18. The presentation unit 20 may present (e.g., display) the virtual keyboard. An example of such displayed virtual keyboard may be shown in FIGS. 4A-4D. As shown, virtual keys and/or corresponding characters may be emphasized (e.g., their display characteristic may be altered by) using larger keys for particular characters that may be likely to be selected next by a user. According to an example, the virtual keys and/or corresponding characters may be emphasized based on input in the text box and/or a probability or likelihood of a character being selected next by a user, for example, based on such input as described herein (e.g., below).

According to one or more examples, the text controller 16 may receive or obtain from the user input recognition unit 14 a user interest indication indicating interest in a particular character (e.g., a user's gaze approaches and/or fixates the particular character). As shown, it may be characters that may be used to complete the abbreviation qtly or word quarterly. The text controller 16 (e.g., in connection with the presentation controller 18 and/or the presentation unit 20) may adjust the display characters of other virtual keys and/or the corresponding characters as the user beings to complete qtly by receiving the user interest indication of q, followed by t, followed by l, for example, and, subsequently, y. For example, as shown in FIGS. 4B-4C, the most likely character for a giver user in a context (e.g., to complete qtly or quarterly) may be a u, 1, and/or t. As such, target area for the virtual key associated with y and/or the character u, 1, and/or tin the virtual key may be increased and/or offset while the target area for the rest of the virtual keys may be stay the same or be compressed and/or not offset.

According to examples herein, the virtual keys and/or a corresponding set of characters that may include one or more characters that may be likely to be used next by a user and, thus, presented in a virtual keyboard layout (e.g., that may be determined and/or generated by the text controller 16) may be based on a distribution of words in a dictionary selected using one or more criterion or criteria as described herein. Additionally, as described herein, display characteristics of at least a portion of those virtual keys and/or corresponding characters may be altered based on a probability (e.g., greater than or equal to 20% chance) of the characters being selected next as described herein (e.g., u, t, and/or l may be enlarged and/or other characters compressed as shown in FIG. 4B-C based on a probability of greater than or equal to 20% chance of being selected next when viewed with the text q entered in the text box).

Additionally, as shown in FIG. 4D, character clusters (e.g., 76) may be provided in a virtual keyboard having a virtual keyboard layout as shown. In an example, the text controller 16 may generate and/or determine a virtual keyboard as shown in FIG. 4D as described herein. The character cluster may be based on them being likely to be used next by a user as described herein and/or display characteristics thereof may be altered and/or emphasized (e.g., added, offset, and/or emphasized) based on the probability as described herein. For example, with the text “It's mu” input in the text box as shown in FIG. 4D, the device (e.g., the text controller 16) may determine that the likely characters to be used by a user next may be “dd”, “gg” or “mm.” These character clusters may be provided (e.g., added, offset, and/or otherwise emphasized) in a middle row of the QWERTY keyboard.

In examples herein, one or more virtual keys and/or characters or corresponding characters may be shown with variations in size corresponding to their frequency of occurrence (e.g., as described and/or shown in FIGS. 2B-4D). For example, the frequency of occurrence may be determined based on the specific user's prior text entry. The frequency of occurrence may be determined based on the specific user's prior text entry in the application 22 (e.g., an application that may be current running and/or in focus on the device). According to an example, the frequency of occurrence may be determined based on the word or sentence entered into a user-interface component for displaying accepted/received input (e.g., during a current session, response message, etc.). For example, given “st” may be received as input, a “c” may be unlikely but an “r” may be likely.

Further, according to an example, the symbols and/or numerals may be displayed in various arrangements, such as in a line or in a grid. The symbols and/or numerals may be displayed in bold or in different sizes depending upon their relevance to the user and the current text entry. In certain representative embodiments, a character variant may include a version of the character with accents or diacritics. In an example, such variants may be classified based on frequency of occurrence and/or relevance to the user. Further, the symbols may be spaced farther away depending upon their frequency of occurrence and/or relevance to the user.

As described herein, in an example, the text controller 16 may partition an alphabet into one or more sub-alphabets and/or in a QWERTY layout. The text controller 16 may determine a relative position for each of the sub-alphabets and/or virtual keys on the presentation unit 16. The text controller 16 may determine one or more display features (e.g., display characteristics) for each (or some) of the characters in each (or some) of the sub-alphabets and/or the virtual keys. These display features may include, for example, size, boldness and/or any other emphasis. The text controller 16 may determine one or more variants for each (or some) of the characters. The text controller 16 in connection with the presentation controller 18 and the presentation unit 20 may display the variants, if any, for the character on which the user's gaze fixates.

Additionally, according to examples herein, the text controller 16 may determine the display features of a character based on its frequency of occurrence given application context. In certain representative embodiments, the text controller 16 may determine the display features of a character based on its frequency of occurrence given the user's history of data (text) entry. The text controller 16 may determine the display features of a character based on its frequency of occurrence given the application context and the user's history of data (text) entry in an example.

The variants for a character may include the most frequently occurring “clusters” beginning from the given character given any combination of the application context and user's history of text entry. As an example, on “q”, a “qu” suggestion may be shown. As another example, after “c” upon gazing at “r”, the suggestions [“ra”, “re”, “ri”, “ro”, “ru”, “ry”] may be shown. Such suggestions may be shown in view of covering many possibilities of the combination of the letters “cr”.

According to examples, the variants for a character may include the most frequently occurring words given any combination of the application context and user's history of text entry. For example, if there may be no prior character and the user gazes on “t”, the suggestion such as [“to”, “the”, “the”] may be displayed.

The system may facilitate data entry, via a user interface, using a virtual keyboard. The text controller 16 (e.g., in connection with the presentation controller 18 and/or the presentation unit 20) may adapt the virtual keyboard to present, inter alia, an alphabet partitioned into first and second sub-alphabets. The first sub-alphabet may include only consonants (consonants sub-alphabet). The second sub-alphabet may include only vowels (vowels sub-alphabet). The text controller 16 may generate a virtual keyboard layout. The presentation unit 20 may display the virtual keyboard, on a display associated with the user interface, in accordance with the virtual keyboard layout. The virtual keyboard layout may include first and second sub-alphabet regions positioned adjacent to each other. The first sub-alphabet region may be populated with only the consonants sub-alphabet or some of the consonants thereof. The second sub-alphabet region may be populated with only the vowels sub-alphabet or some of the vowels thereof.

The first sub-alphabet region may include a separate sub-region (virtual key) for each consonant disposed therein. The text controller 16 (e.g., in connection with the presentation controller 18 and/or the presentation unit 20) may map the first sub-alphabet sub-regions to corresponding positions on the display. Such mapping may allow selection of consonants as input via the user-recognition unit 14. In certain representative embodiments, the second sub-alphabet region may include a separate sub-region (virtual key) for each vowel. The text controller 16 (e.g., in connection with the presentation controller 18 and/or the presentation unit 20) may map the second sub-alphabet sub-regions to corresponding positions on the display. This mapping may allow selection of vowels as input via the user-recognition unit 14.

The virtual keyboard layout may include a third sub-alphabet region. The third sub-alphabet region may be positioned adjacent to, and separated from the first sub-alphabet region by, the second sub-alphabet region. In certain representative embodiments, the first sub-alphabet region may be populated with only frequently-used consonants, and the third sub-alphabet region may be populated with the remaining consonants of the consonants sub-alphabet.

In certain representative embodiments, the third sub-alphabet region may include a separate sub-region (virtual key) for each consonant disposed therein. The text controller 16 (e.g., in connection with the presentation controller 18 and/or the presentation unit 20) may map the third sub-alphabet sub-regions to corresponding positions on the display. Such mapping may allow selection of the consonants disposed therein as input via the user-recognition unit 14.

In certain representative embodiments, the virtual keyboard layout may include a symbols region. The symbols region may be in a collapsed state when not active and in an expanded state when active. In the expanded state, the symbols region may include one or more symbols. The text controller 16 (e.g., in connection with the presentation controller 18 and/or the presentation unit 20) may make such symbols, viewable via the display, and selectable via the user-recognition unit 14. In the collapsed state, none of the symbols are viewable. In certain representative embodiments, the virtual keyboard layout may include a symbols-region anchor to which the symbols region may be anchored. The text controller 16 (e.g., in connection with the presentation controller 18 and/or the presentation unit 20) may position the symbols-region anchor adjacent to the first and second sub-alphabet regions, for example.

In certain representative embodiments, the symbols region may include a separate sub-region (virtual key) for each symbol disposed therein. The text controller 16 (e.g., in connection with the presentation controller 18 and/or the presentation unit 20) may map the symbol sub-regions to corresponding positions on the display, and such mapping may allow selection of symbols as input via the user-recognition unit 14.

In certain representative embodiments, the virtual keyboard layout may include a numerals region. The numerals region may be in a collapsed state when not active and in an expanded state when active. In the expanded state, the numerals region may include one or more numerals. The text controller 16 (e.g., in connection with the presentation controller 18 and/or the presentation unit 20) may make such numerals, viewable via the display, and selectable via the user-recognition unit 14. In the collapsed state, none of the numerals are viewable. In certain representative embodiments, the virtual keyboard layout may include a numerals-region anchor to which the numerals region may be anchored. The text controller 16 (e.g., in connection with the presentation controller 18 and/or the presentation unit 20) may position the numerals-region anchor adjacent to the first and second sub-alphabet regions.

In certain representative embodiments, the text controller 16 (e.g., in connection with the presentation controller 18 and/or the presentation unit 20) may apply visual emphasis to any consonant, vowel, symbol, numeral and/or any other character (“emphasized character”). The emphasis applied to the emphasized character may include one or more of the following: (i) highlighting, (ii) outlining, (iii) shadowing, (iv) shading, (v) coloring, (vi) underlining, (v) a font different from an un-emphasized character and/or another emphasized character, (vi) a font weight (e.g., bolded/unbolded font) different from an un-emphasized character and/or another emphasized character, (vii) a font orientation different from an un-emphasized character and/or another emphasized character, (viii) a font width different from an un-emphasized character and/or another emphasized character, (ix) a font size different from an un-emphasized character and/or another emphasized character, (x) a stylistic font variant (e.g., regular (or roman), italicized, condensed, etc., style) different from an un-emphasized character and/or another emphasized character, (xi) and/or any typographic feature or format and/or other graphic or visual effect that distinguishes the emphasized character from an un-emphasized character.

In certain representative embodiments, the text controller 16 (e.g., in connection with the presentation controller 18 and/or the presentation unit 20) may apply visual emphasis to some of the emphasized characters that may distinguish such emphasized characters from other emphasized characters.

In certain representative embodiments, the text controller 16 (e.g., in connection with the presentation controller 18 and/or the presentation unit 20) may apply the visual emphasis to a character based, at least in part, on a frequency of occurrence of the character in a sample/baseline text.

In certain representative embodiments, the text controller 16 (e.g., in connection with the presentation controller 18 and/or the presentation unit 20) may apply the visual emphasis to a character based, at least in part, on a frequency of occurrence of the character in one or more prior, and/or a stored history of, entries (e.g., made via the user interface or otherwise received).

In certain representative embodiments, the text controller 16 (e.g., in connection with the presentation controller 18 and/or the presentation unit 20) may apply the visual emphasis to a character based, at least in part, on a frequency of occurrence of the character in one or more prior, and/or a stored history of, entries (e.g., made via the user interface or otherwise received) for a particular application.

In certain representative embodiments, the text controller 16 (e.g., in connection with the presentation controller 18 and/or the presentation unit 20) may apply the visual emphasis to a character based, at least in part, on a frequency of occurrence of the character in one or more prior, and/or a stored history of, entries (e.g., made via the user interface or otherwise received) for a particular application currently being used.

In certain representative embodiments, the user-recognition unit 14 (e.g., in connection with the test controller 16, presentation controller 18 and/or the presentation unit 20) may determine which character of the virtual keyboard may be of interest to a user. The text controller 16 (e.g., in connection with the presentation controller 18 and/or the presentation unit 20) may display a suggestion associated with the determined character of interest.

The user-recognition unit 14 may determine which character may be of interest to the user based on (or responsive to) receiving an interest indication corresponding to the character. This interest indication may be based, at least in part, on a determination that the user's gaze may be fixating on the character of interest. Alternatively and/or additionally, the interest indication may be based, at least in part, on a user input making a selection of the character of interest (e.g., selecting via a touchscreen).

In certain representative embodiments, the text controller 16 in connection with the presentation controller 18 and/or the presentation unit 20 may display one or more suggestions adjacent to the determined character of interest. The suggestions may include, for example, one or more of: (i) a variant of the determined character of interest (e.g., upper/lower case, and others listed above); (ii) a word root; (iii) a lemma of a word; (iv) a character cluster; (IT) a word stem associated with the determined character of interest; and/or (vi) a word associated with the determined character of interest. One or more of the suggestions may be based, at least in part, on language usage associated with the determined character of interest.

In certain representative embodiments, one or more of the suggestions may be based, at least in part, on one or more prior, and/or a stored history of, entries (e.g., made via the user interface or otherwise received). In certain representative embodiments, one or more of the suggestions may be based, at least in part, one or more prior, and/or a stored history of, entries (e.g., made via the user interface or otherwise received) for a particular application. In certain representative embodiments, one or more of the suggestions may be based, at least in part, on one or more prior, and/or a stored history of, entries (e.g., made via the user interface or otherwise received) for a particular application currently being used. In certain representative embodiments, one or more of the suggestions may be based, at least in part, on one or more frequently occurring prior, and/or a stored history of, entries (e.g., made via the user interface or otherwise received). In certain representative embodiments, one or more of the suggestions may be based, at least in part, on one or more frequently occurring prior, and/or a stored history of, entries (e.g., made via the user interface or otherwise received) for a particular application.

In certain representative embodiments, the user-recognition unit 14 (e.g., in connection with the test controller 16, presentation controller 18 and/or the presentation unit 20) may determine whether one (or more) the displayed suggestions may be selected. In certain examples, the user-recognition unit 14 (e.g., in connection with the test controller 16, presentation controller 18 and/or the presentation unit 20) may receive and/or accept the displayed suggestion as input to an application on condition that the displayed suggestion may be selected. In certain representative embodiments, the text controller 16 in connection with the presentation controller 18 and/or the presentation unit 20 may display the suggestion in a user-interface region for displaying accepted/received input.

In certain representative embodiments, the system may facilitate data entry, via a user interface, using a virtual keyboard adapted to present an alphabet partitioned into first and second sub-alphabets. The first sub-alphabet may include only consonants (consonants sub-alphabet), and the second sub-alphabet may include only vowels (vowels sub-alphabet). The text controller 16 in connection with the presentation controller 18 and/or the presentation unit 20 may display the virtual keyboard having first and second sub-alphabet regions positioned adjacent to each other. The first sub-alphabet region may be populated with only the consonants sub-alphabet or some of the consonants thereof. The second sub-alphabet region being populated with only the vowels sub-alphabet or some of the vowels thereof. The user-recognition unit 14 (e.g., in connection with the test controller 16, presentation controller 18 and/or the presentation unit 20) may determine which displayed consonant or vowel may be of interest to a user. The text controller 16 in connection with the presentation controller 18 and/or the presentation unit 20 may display one or more suggestions associated with the determined consonant or vowel of interest.

In examples, the user-recognition unit 14 (e.g., in connection with the test controller 16, presentation controller 18 and/or the presentation unit 20) may determine whether a displayed suggestion may be selected. The user-recognition unit 14 (e.g., in connection with the test controller 16, presentation controller 18 and/or the presentation unit 20) may receive and/or accept the displayed suggestion as input to an application on condition that the displayed suggestion may be selected. In certain representative embodiments, the text controller 16 in connection with the presentation controller 18 and/or the presentation unit 20 may display the suggestion in a user-interface region for displaying accepted/received input.

The methods, apparatuses and systems provided herein are well-suited for communications involving both wired and wireless networks. Wired networks are well-known. An overview of various types of wireless devices and infrastructure may be provided with respect to FIGS. 5A-5E, where various elements of the network may utilize, perform, be arranged in accordance with and/or be adapted and/or configured for the methods, apparatuses and systems provided herein.

FIGS. 5A-5E (collectively FIG. 5) are block diagrams illustrating an example communications system 100 in which one or more disclosed embodiments may be implemented. In general, the communications system 100 defines an architecture that supports multiple access systems over which multiple wireless users may access and/or exchange (e.g., send and/or receive) content, such as voice, data, video, messaging, broadcast, etc. The architecture also supports having two or more of the multiple access systems use and/or be configured in accordance with different access technologies. This way, the communications system 100 may service both wireless users capable of using a single access technology, and wireless users capable of using multiple access technologies.

The multiple access systems may include respective accesses; each of which may be, for example, an access network, access point and the like. In various embodiments, all of the multiple accesses may be configured with and/or employ the same radio access technologies (“RATs”). Some or all of such accesses (“single-RAT accesses”) may be owned, managed, controlled, operated, etc. by either (i) a single mobile network operator and/or carrier (collectively “MNO”) or (ii) multiple MNOs. In various embodiments, some or all of the multiple accesses may be configured with and/or employ different RATs. These multiple accesses (“multi-RAT accesses”) may be owned, managed, controlled, operated, etc. by either a single MNO or multiple MNOs.

The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 5A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals, and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, a terminal or like-type device capable of receiving and processing compressed video communications, or like-type device.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), Node-B (NB), evolved NB (eNB), Home NB (HNB), Home eNB (HeNB), enterprise NB (“ENT-NB”), enterprise eNB (“ENT-eNB”), a site controller, an access point (AP), a wireless router, a media aware network element (MANE) and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 5A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 5A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 5A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 5A may be configured to communicate with the base station 114a, which may employ a cellular-based radio technology, and with the base station 114b, which may employ an IEEE 802 radio technology.

FIG. 5B is a system diagram of an example WTRU 102. As shown in FIG. 5B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138 (e.g., a camera or other optical capturing device). It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a graphics processing unit (GPU), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 5B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 5B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 5C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 5C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 5C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 5C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 5D is a system diagram of the RAN 104 and the core network 106 according to another embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode Bs 160a, 160b, 160c, though it will be appreciated that the RAN 104 may include any number of eNode Bs while remaining consistent with an embodiment. The eNode Bs 160a, 160b, 160c may each include one or more transceivers for communicating with the WTRUs 102a, 102b, 102c over the air interface 116. In one embodiment, the eNode Bs 160a, 160b, 160c may implement MIMO technology. Thus, the eNode B 160a, for example, may use multiple antennas to transmit wireless signals to, and receive wireless signals from, the WTRU 102a.

Each of the eNode Bs 160a, 160b, 160c may be associated with a particular cell (not shown) and may be configured to handle radio resource management decisions, handover decisions, scheduling of users in the uplink and/or downlink, and the like. As shown in FIG. 5D, the eNode Bs 160a, 160b, 160c may communicate with one another over an X2 interface.

The core network 106 shown in FIG. 5D may include a mobility management gateway (MME) 162, a serving gateway (SGW) 164, and a packet data network (PDN) gateway (PGW) 166. While each of the foregoing elements are depicted as part of the core network 106, it will be appreciated that any one of these elements may be owned and/or operated by an entity other than the core network operator.

The MME 162 may be connected to each of the eNode Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular SGW during an initial attach of the WTRUs 102a, 102b, 102c, and the like. The MME 162 may also provide a control plane function for switching between the RAN 104 and other RANs (not shown) that employ other radio technologies, such as GSM or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The SGW 164 may also be connected to the PGW 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 5E is a system diagram of the RAN 104 and the core network 106 according to another embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 5E, the RAN 104 may include base stations 170a, 170b, 170c, and an ASN gateway 172, though it will be appreciated that the RAN 104 may include any number of base stations and ASN gateways while remaining consistent with an embodiment. The base stations 170a, 170b, 170c may each be associated with a particular cell (not shown) in the RAN 104 and may each include one or more transceivers for communicating with the WTRUs 102a, 102b, 102c over the air interface 116. In one embodiment, the base stations 170a, 170b, 170c may implement MIMO technology. Thus, the base station 170a, for example, may use multiple antennas to transmit wireless signals to, and receive wireless signals from, the WTRU 102a. The base stations 170a, 170b, 170c may also provide mobility management functions, such as handoff triggering, tunnel establishment, radio resource management, traffic classification, quality of service (QoS) policy enforcement, and the like. The ASN gateway 172 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 170a, 170b, 170c may be defined as an R8 reference point that includes protocols for facilitating WTRU handovers and the transfer of data between base stations. The communication link between the base stations 170a, 170b, 170c and the ASN gateway 172 may be defined as an R6 reference point. The R6 reference point may include protocols for facilitating mobility management based on mobility events associated with each of the WTRUs 102a, 102b, 102c.

As shown in FIG. 5E, the RAN 104 may be connected to the core network 106. The communication link between the RAN 14 and the core network 106 may defined as an R3 reference point that includes protocols for facilitating data transfer and mobility management capabilities, for example. The core network 106 may include a mobile IP home agent (MIP-HA) 174, an authentication, authorization, accounting (AAA) server 176, and a gateway 178. While each of the foregoing elements are depicted as part of the core network 106, it will be appreciated that any one of these elements may be owned and/or operated by an entity other than the core network operator.

The MIP-HA 174 may be responsible for IP address management, and may enable the WTRUs 102a, 102b, 102c to roam between different ASNs and/or different core networks. The MIP-HA 174 may provide the WTRUs 102a, 102b, 102c with access to packet-switched networks, such as the Internet 11, to facilitate communications between the WTRUs 102a, 102b, 102c and IP-enabled devices. The AAA server 176 may be responsible for user authentication and for supporting user services. The gateway 178 may facilitate interworking with other networks. For example, the gateway 178 may provide the WTRUs 102a, 102b, 102c with access to circuit-switched networks, such as the PSTN 108, to facilitate communications between the WTRUs 102a, 102b, 102c and traditional land-line communications devices. In addition, the gateway 178 may provide the WTRUs 102a, 102b, 102c with access to the networks 112, which may include other wired or wireless networks that are owned and/or operated by other service providers.

Although not shown in FIG. 5E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

Although the terms device, smartglasses, UE, WTRU, wearable device, and/or the like may be used herein, it may and should be understood that the use of such terms may be used interchangeably and, as such, may not be distinguishable.

Further, although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for facilitating data entry, via a user interface displayed on a device, using a virtual keyboard adapted to present an alphabet, the method comprising:
generating a virtual keyboard layout, the virtual keyboard layout comprising a set of virtual keys, the set of virtual keys comprising a corresponding set of characters likely to be used next by a user of the virtual keyboard, the set of characters comprising one or more characters selected based on a distribution of words in a dictionary selected using one or more criteria; and
altering display characteristics of at least a portion of the set of virtual keys of the virtual keyboard layout based on a probability of the one or more characters of the corresponding virtual keys being used next by the user of the virtual keyboard, wherein altering the display characters comprises at least increasing a target area of at least one of the virtual keys comprising the one or more characters likely to be used next by the user of the virtual keyboard based on the probability and compressing a target area of one or more of the virtual keys comprising the one or more characters not likely to be used next by the user of the virtual keyboard based on the probability;
altering display characteristics of the virtual keyboard layout based on at least one of movement of an eye of a user or a gaze of the user; and
displaying the virtual keyboard using the virtual keyboard layout including the altered display characteristics of the portion of the set of virtual keys.

2. The method of claim 1, wherein the criteria comprises at least one of the following: a system language configured by the user or one or more previously used characters, words or text in an application.

3. The method of claim 2, wherein the system language configured by the user is determined by identifying a language in which the user is working based on at least one of the following: captured characters, words or text entered by the user, characters, words, or text the user is reading or responding to, or a language detector.

4. The method of claim 2, wherein the application comprises at least one of the following: any application on the device used or an application currently in use on the device.

5. The method of claim 1, wherein the probability comprises a twenty percent or greater chance of the one or more characters being used next by the user.

6. The method of claim 5, wherein the portion of the set of virtual keys comprises at least one key for each row, the at least one key for each row comprising a key from the set of virtual keys associated with a character from the set of characters having a greatest probability from the probability associated with the one or more characters of being used next by the user.

7. The method of claim 1, wherein altering the display characteristics of the at least the portion of the set of virtual keys comprises one or more of the following: increasing a width of a virtual key or a corresponding character included in the virtual key or increasing a height of the virtual key, or moving the key in a given direction, or the corresponding character included in the virtual key or the luminance of the color, or the contrast of the color, or the shape of the virtual key.

8. The method of claim 7, wherein the width of the virtual key or the corresponding character is increased up to fifty percent compared to other virtual keys or the corresponding characters in the set of virtual keys and the corresponding set of virtual characters.

9. The method of claim 8, wherein the other virtual keys and the corresponding characters in a row with the virtual key are the corresponding character are offset from the virtual key and the corresponding character.

10. The method of claim 7, wherein the height of the virtual key or the corresponding character included in the virtual key is increased up to fifty percent compared to other virtual keys or the corresponding characters in the set of virtual keys and the corresponding set of virtual characters.

11. The method of claim 10, wherein the height of the virtual key or the corresponding character is increased in a particular direction depending on which row the virtual key or the corresponding character is included.

12. The method of claim 1, wherein the at least the portion of the set of virtual keys for which the display characteristics are altered comprises each virtual keys in the set of the virtual keys.

13. The method of claim 12, wherein the display characteristics of each virtual keys are altered is based on a grouping or bin to which each virtual key belongs to.

14. The method of claim 13, wherein the grouping or bin has a range of probabilities associated therewith and the grouping or bin to which each virtual key belongs is based on the probability associated with each virtual key being within the range of probabilities.

15. The method of claim 14, wherein the virtual keys or the corresponding characters in a grouping or bin having the virtual keys with higher probabilities within the range of probabilities of being used next are altered more than the virtual keys or the corresponding characters in a grouping or bin having the virtual keys with higher probabilities within the range of probabilities of being used next.

16. The method of claim 1, wherein the one or more characters in the set of characters are consonants.

17. The method of claim 1 wherein the one or more characters in the set of characters are vowels.

18. A method for facilitating data entry, via a user interface displayed on a device, using a virtual keyboard adapted to present an alphabet, the method comprising:
generating a virtual keyboard layout, the virtual keyboard layout comprising a set of virtual keys, the set of virtual keys comprising a corresponding set of characters or character clusters likely to be used next by a user of the virtual keyboard, the set of characters comprising respective characters likely to be used next by the user selected based on a distribution of words or characters, the set of character clusters comprising at least two respective characters likely to be used next by the user selected based on the distribution of words or characters, and the set of characters being provided in the corresponding virtual keys in at least a first row of the virtual keyboard layout and the set of character clusters being provided in the corresponding virtual keys in at least a second row of the virtual keyboard layout;
altering display characteristics of the virtual keyboard layout based on at least one of movement of an eye of a user or a gaze of the user; and
displaying the virtual keyboard using the virtual keyboard layout.

19. The method of claim 18, wherein the distribution of words is determined using a dictionary.

20. The method of claim 18, wherein the dictionary is configured to be selected using one or more criteria.

21. The method of claim 20, wherein the criteria comprises at least one of the following: a system language configured by the user or one or more previously used characters, or words or text in an application.

22. The method of claim 21, wherein the system language configured by the user is determined by identifying a language in which the user is working based on at least one of the following: captured characters, words or text entered by the user, characters, words, or text the user is reading or responding to, or a language detector.

23. The method of claim 21, wherein the application comprises at least one of the following: any application on the device used or an application currently in use on the device.

24. The method of claim 18, wherein the distribution of words is determined using entry of words or text in the application or text box associated therewith.

25. The method of claim 18, wherein the distribution of words is determined using a frequency of the words or the one or more characters being used by the user.

26. The method of claim 25, further comprising:
determining whether space for the second row or one or more additional rows may be available in the virtual keyboard layout of the virtual keyboard;
determining the one or more character clusters frequently occurring or likely to be used next by the user based on at least one of the following: a dictionary, text entry by the user, or text entry of a plurality of users;
for each of the determined character clusters frequently occurring or likely to be used next by the user, selecting at least a subset of the character clusters;
altering the virtual keyboard layout to include the at least the subset of character clusters.

27. The method of claim 26, wherein selecting the at least the subset of the character clusters further comprises one or more of the following:
grouping the character clusters by the second row or the one or more additional rows;
determining a number of the virtual keys associated with the character clusters that are available to be included in the second row or the one or more additional rows;
determining a sum of the frequency for each of the character clusters for potential inclusion in the second row or the one or more additional rows;
determining the at least the subset of character clusters with a highest combined frequency based on the sum; and
selecting the at least the subset of character clusters based on the highest combined frequency and the number of the virtual keys that are available to be included in the second row or the one or more additional rows.

28. The method of claim 1, further comprising displaying a double letter key in response to a user inputting a letter.

29. The method of claim 1, further comprising displaying a key comprising a predicted set of letters based on a prediction of the set of letters that follow a letter inputted by a user and that do not include the letter inputted by the user.
